(19) United States
(12) Patent Application Publication
(10) Pub. No.: US 2026/0278596 A1
(43) Pub. Date: Sep. 17, 2026

(54) System and Method of Data Verification

(71) Applicant: DATA VERIFICATION PARTNERS, LLC, ACTON, MA (US)

(72) Inventors: Stephen Wilson, Yamba (AU); George Shattuck Peabody, Acton, MA (US)

(21) Appl. No.: 19/166,691

(22) PCT Filed: Mar. 20, 2024
(86) PCT No.: PCT/US2024/020802

§ 371 Date: Sep. 18, 2025

Related U.S. Application Data
(60) Provisional application No. 63/491,250, filed on Mar. 20, 2023.
(60) Provisional application No. 63/500,264, filed on May 4, 2023.

(51) Int. Cl. G06Q 20/38; G06Q 20/36

(52) U.S. Cl. CPC G06Q 20/3825; G06Q 20/3674

(57) ABSTRACT

This application is directed to user authentication and data verification. A computing system executes a data verification application for verifying user data of an individual user on behalf of an origin entity in response to a request received from a requester account. The request includes payload data and a payload digital signature, and the payload data further includes the user data and a first digital signature. A requester public key associated with the requester account is extracted from a database and used to decrypt the payload digital signature and verify the payload data and the requester account. Upon verification, a first origin entity is identified based on the payload data, and an origin public key is extracted and used to decrypt the first digital signature and further verify whether the user data as received via the first requester account are issued by the origin entity.

### RELATED APPLICATION

This application claims priority to U.S. Provisional Patent Application No. 63/491,250, filed Mar. 20, 2023, titled “Methods and Systems of Data Verification,” and U.S. Provisional Patent Application No. 63/500,264, filed May 4, 2023, titled “Methods and Systems of Data Verification,” each of which is incorporated by reference in its entirety.

### TECHNICAL FIELD

The disclosed embodiments relate generally to data processing including, but not limited to, methods, systems, and non-transitory computer-readable storage media for verifying authenticity or other properties of critical data issued by a plurality of origin entities in response to inquiries received from registered user accounts.

### BACKGROUND

Data security technologies, often reliant on encryption mechanisms, are applied by different parities to distribute critical data created by themselves to targeted users. The sensitive data protected by the encryption mechanisms are strictly controlled by the issuing parties, and distributed to the targeted users directly or to a party interested in the critical data. This imposes a tremendous burden on each individual party who issues the sensitive data, and however, does not have expertise in managing encryption mechanisms.

### SUMMARY

Various embodiments of this application are directed to methods, systems, and non-transitory computer-readable storage media for establishing a data verification platform (DVP) for managing metadata (properties of data that make user data fit for purpose) and public keys of a plurality of origin entities and verifying critical user data, of individual users, issued by these origin entities using the metadata in response to inquiries received from registered user accounts of the DVP. The data verification platform is enabled by a server system via a data verification application providing a plurality of user accounts to a plurality of users (e.g., origin entities and organization users). The origin entities issue user data of individual users with digital signatures in a digital format, and provide the metadata and entity public keys to the sever system. As the individual users present the user data and digital signatures stored on their mobile devices to the organization users' electronic devices, the organization users requests the server system to verify the user data and the digital signatures based on the public keys previously provided to, and stored on, a database associated with the server system. As such, the DVP can efficiently manage data verification tasks ad hoc for a plurality of different origin entities, a plurality of individual users, and a plurality of organization users in a consolidated manner.

In one aspect, a method is implemented to verify data at a computing system having one or more processors and memory. The method includes executing a data verification application for verifying user data of a plurality of individual users on behalf of a plurality of origin entities that issue the user data. The data verification application is coupled to a database stores, for each of a plurality of origin entities, (1) a respective origin public key corresponding to a set of user data issued by the respective origin entity to a subset of the plurality of individual users and (2) metadata that is associated with the set of user data and provided by the respective origin entity. The method further includes receiving, from a first requester account, a data verification request including payload data and a payload digital signature associated with the payload data. The payload data further includes first user data of a first individual user and a first digital signature associated with the first user data. The method further includes, in response to the data verification request, extracting, from the database, a requester public key associated with the first requester account, decrypting the payload digital signature associated with the payload data using the requester public key associated with the first requester account to generate a decrypted payload digital signature, and verifying whether the payload data, received from the first requester account, are generated by the first requester account based on the decrypted payload digital signature. The method further comprises, in accordance with a verification of the payload data, obtaining the payload data including the first digital signature and the first user data of the first individual user, identifying a first origin entity that has issued the first user data of the first individual user based on the payload data, extracting, from a database, an origin public key associated with the first origin entity, decrypting the first digital signature associated with the first user data using the origin public key associated with the first origin entity to generate a decrypted first digital signature, and based on the decrypted first digital signature, verifying whether the first user data, received via the first requester account, are issued by the first origin entity.

In some embodiments, the metadata associated with the set of users include one or more data processing criteria for using the set of user data issued by the respective origin entity to the subset of the plurality of individual users. The method further includes, after identifying the first origin entity, extracting, from the database, a first data processing criterion, and applying the first data processing criterion to the first user data associated with the first individual user to generate a confirmation indicating whether the first user data satisfy the first data processing criterion.

In some embodiments, the method further includes, in accordance with a verification that the first user data are issued by the first origin entity, generating a message associated with the first individual user based on the first user data and a subset of the metadata, wherein the subset of the metadata is associated with the first user data and provided by the first origin entity. The method further includes sending the message to the first requester account.

In another aspect, a method is implemented to verify data at a computing system having one or more processors and memory. The method includes executing a data verification application for verifying user data of a plurality of individual users on behalf of a plurality of origin entities that issue the user data. The method further includes storing (1) a plurality of origin public keys received from the plurality of origin entities and (2) metadata that is associated with a set of user data and provided by each origin entity in a database. Each of a plurality of origin entities has a respective origin public key corresponding to a set of user data issued by the respective origin entity to a subset of the plurality of individual users. The method further includes storing a plurality of requester public keys received from a plurality of requester accounts associated with a plurality of organization users in the database. Each of the plurality of requester accounts has a respective requester public key used to verify data received from the respective requester account. The method further includes receiving, from a first requester account, a data verification request including payload data and a payload digital signature associated with the payload data, the payload data further including first user data of a first individual user and a first digital signature associated with the first user data. The method further includes, in response to the data verification request, extracting, from the database, a requester public key associated with the first requester account and applying the requester public key to verify whether the payload data, received from the first requester account, are generated by the first requester account. The method further includes, in accordance with a verification of the payload data, identifying a first origin entity that has issued the first user data of the first individual user based on the payload data, extracting, from a database, an origin public key associated with the first origin entity, and applying the origin public key to verify whether the first user data, received via the first requester account, are issued by the first origin entity.

In another aspect, a server system includes one or more processors and memory having instructions stored thereon, which when executed by the one or more processors cause the processors to perform operations for any of the above described methods.

In yet another aspect, a non-transitory computer-readable storage medium has instructions stored thereon, which when executed by one or more processors of a server system cause the processors to perform operations for any of the above described methods.

### BRIEF DESCRIPTION OF THE DRAWINGS

For a better understanding of the aforementioned systems, methods, and graphical user interfaces, as well as additional systems, methods, and graphical user interfaces, reference should be made to the Description of Embodiments below, in conjunction with the following drawings and appendices.

FIG. 1 is a block diagram illustrating an example network architecture that enables a multi-user data verification system, in accordance with some embodiments.

FIG. 2 is a flow diagram of an example process of verifying user data in a multi-user data verification platform, in accordance with some embodiments.

FIG. 3 is a flow diagram of an example process of managing first user data in data verification, in accordance with some embodiments.

FIG. 4A is a flow diagram of an example process of generating a first digital signature of first user data, in accordance with some embodiments.

FIG. 4B is a flow diagram of an example process of verifying a first digital signature of first user data, in accordance with some embodiments.

FIG. 5 is a block diagram of an example verifiable data structure of first user data, in accordance with some embodiments.

FIG. 6 is a block diagram illustrating an example data verification environment in which artificial intelligence is used to watermark user information, in accordance with some embodiments.

FIG. 7 is a block diagram illustrating a representative computing system, in accordance with some embodiments.

FIG. 8 is a flow diagram of an example method of verifying user data, in accordance with some embodiments.

Reference will now be made to embodiments, examples of which are illustrated in the accompanying drawings. In the following description, numerous specific details are set forth in order to provide a thorough understanding of the present invention. However, it will be apparent to one of ordinary skill in the art that the present invention may be practiced without requiring these specific details.

### DESCRIPTION OF EMBODIMENTS

Reference will now be made in detail to specific embodiments, examples of which are illustrated in the accompanying drawings. In the following detailed description, numerous non-limiting specific details are set forth in order to assist in understanding the first individual user matter presented herein. But it will be apparent to one of ordinary skill in the art that various alternatives may be used without departing from the scope of claims and the first individual user matter may be practiced without these specific details. For example, it will be apparent to one of ordinary skill in the art that the first individual user matter presented herein can be implemented on many types of computing systems with data processing capabilities.

In accordance with at least some embodiments disclosed herein is the realization that sensitive data used by parties must be fit for purpose with regards to the authority of the source, the age of the data, the processing history of the data, the quality of antecedent raw data and so on. For automatic processing of data to take place, the fitness for purpose of the data must be readily apparent to the processing software; that is, the properties of interest of the data must be “machine-readable”. Properties of data are often represented in “metadata”. In accordance with at least some embodiments disclosed herein is the realization that when parties that use critical data at arm's length from the creators of the data, that is, the parties have no direct relationship with the creators, a tremendous challenge arises in determining fitness for purpose because the metadata is not recognizable or interpretable. The disclosed embodiments include, but not limited to, methods, systems, and non-transitory computer-readable storage media for verifying authenticity or other properties (e.g., provenance, authorship, processing history, pedigree, origin, originality, authority) of critical data issued by a plurality of origin entities in response to inquiries received from registered user accounts.

In accordance with at least some embodiments disclosed herein is the realization that a user receiving verifiable data faces a combinatorial complexity of understanding detailed formats of different verifiable data structures, evaluating origin entities issuing the credentials, verifying that individual users are qualified based on verifiable data, obtaining trusted copies of metadata targets, and obtaining trusted copies of the origin entities' public keys. Some embodiments of the present invention include a type of intermediary—a metadata distributor (MDD)—which takes on the task of reviewing the rules for each type of verifiable credential expected to be presented, and distributing metadata to party a data verification application to automatically recognize relevant credential types. The MDD may provide software components and configuration files containing metadata target values associated with applicable rules. A data verification platform is enabled to provide a higher level infrastructure that brings different parties (e.g., individual, credential issuers, credential verifiers, and MDD) through contracts executed among the different parties.

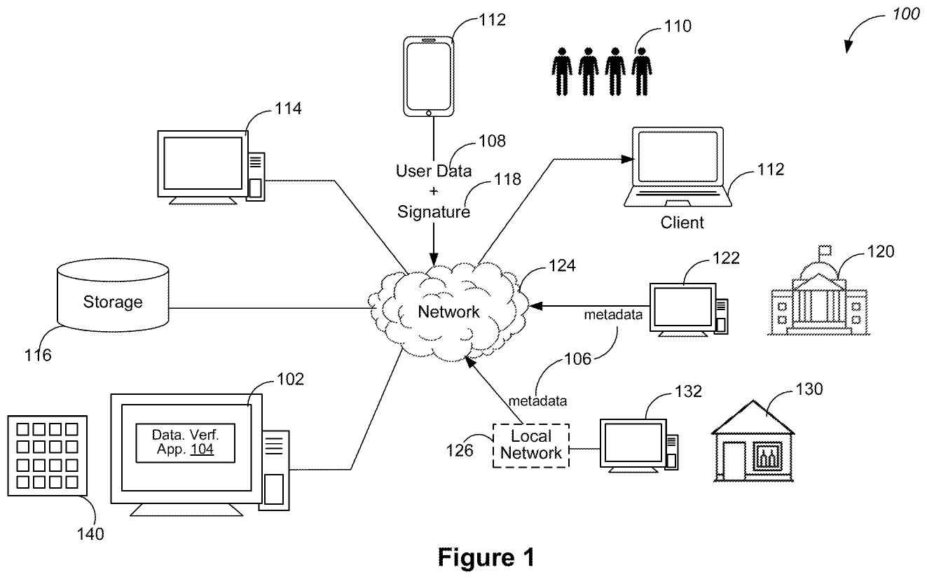

FIG. 1 is a block diagram illustrating an example network architecture that enables a multi-user data verification platform (DVP) 100, in accordance with some embodiments. The DVP 100 provides data verification service to individual users 110, origin entities 120, and organization users 130. The DVP 100 includes one or more servers 102 associated with a metadata distributor 140, a plurality of electronic devices 112 associated with individual users 110, a plurality of electronic devices 122 associated with origin entities 120, and a plurality of electronic devices 132 associated with the organization users 130. The one or more servers 102 hosts a multi-user data verification application 104 configured to collect public keys and metadata 106 (e.g., description of user data, guidance on how to process user data) of the origin entities 120 as well as public keys and supplemental metadata 106 of organization users 130 from the electronic devices 122 and 132, and verify user data 108 of individual users 110 provided by the organization users 130 based on the metadata 106 set by the origin entities 120 and/or the organization users 130. Each of the electronic devices 112, 122, and 132 may be, for example, a desktop computer, a laptop computer, a tablet computer, or a mobile phone. In some embodiments, each electronic device 132 used by an organization user 130 is a point-of-sale (POS) machine. The electronic devices 112, 122, and 132 are applied to collect, pre-process, and store metadata 106 and verifiable data structures associated with the user data 108. Each electronic device 112, 122, or 132 may be further coupled to a third-party server 114 that is distinct from the one or more servers 102 and implements third-party functions. In some embodiments, the multi-user data management platform 100 further includes a storage 116 for storing data related to the servers 102, the electronic devices 112, 122, and 132, and data verification application 104 executed thereon.

More specifically, in some embodiments, the electronic device 122 of the origin entities 120 issue user data 108 of individual users 110 with digital signatures 118 in a digital format, and provide the metadata 106 (e.g., description of user data, guidance on how to process user data) and entity public keys to the sever(s) 102. The user data 108 includes critical user information (e.g., age, home address, biometric information). The origin entities 120 officially issue the user data 108, thereby certifying a validity of the associated user information. The individual users 110 present the user data 108 and digital signatures 118 stored on their electronic devices 112 to the organization users' electronic devices 132. The electronic devices 132 obtain the user data 108 and digital signatures 118, apply additional signatures (not shown), and request the sever(s) 102 to verify the user data 108 based on the digital signatures 118 and the metadata 106 provided to the server(s) 102. More specifically, the digital signatures 118 may be used to verify that the user data 108 originate from the origin entities 120, and the metadata 106 may provide supplemental information to verify reliability or trustworthiness of the user data 108 itself.

The server(s) 102, electronic devices 112, 122, and 132, and storage 116 are communicatively coupled to each other via one or more communication networks 124, which are the medium used to provide communications links between these devices and computers connected together on the multi-user data management platform 100. The one or more communication networks 124 may include connections, such as wire, wireless communication links, or fiber optic cables. Examples of the one or more communication networks 124 include local area networks (LAN), wide area networks (WAN) such as the Internet, or a combination thereof. The one or more communication networks 124 are, optionally, implemented using any known network protocol, including various wired or wireless protocols, such as Ethernet, Universal Serial Bus (USB), FIREWIRE, Long Term Evolution (LTE), Global System for Mobile Communications (GSM), Enhanced Data GSM Environment (EDGE), code division multiple access (CDMA), time division multiple access (TDMA), Bluetooth, Wi-Fi, voice over Internet Protocol (VoIP), Wi-MAX, or any other suitable communication protocol. A connection to the one or more communication networks 124 may be established either directly (e.g., using 3G/4G connectivity to a wireless carrier), or through a network interface 126 (e.g., a router, switch, gateway, hub, or an intelligent, dedicated whole-home control node), or through any combination thereof. As such, in some embodiments, the one or more communication networks 124 can represent the Internet of a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other electronic systems that route data and messages.

More details on different parties, associated participation, and example onboarding processes are also discussed below in “Supplemental Information and Alternative Embodiments.”

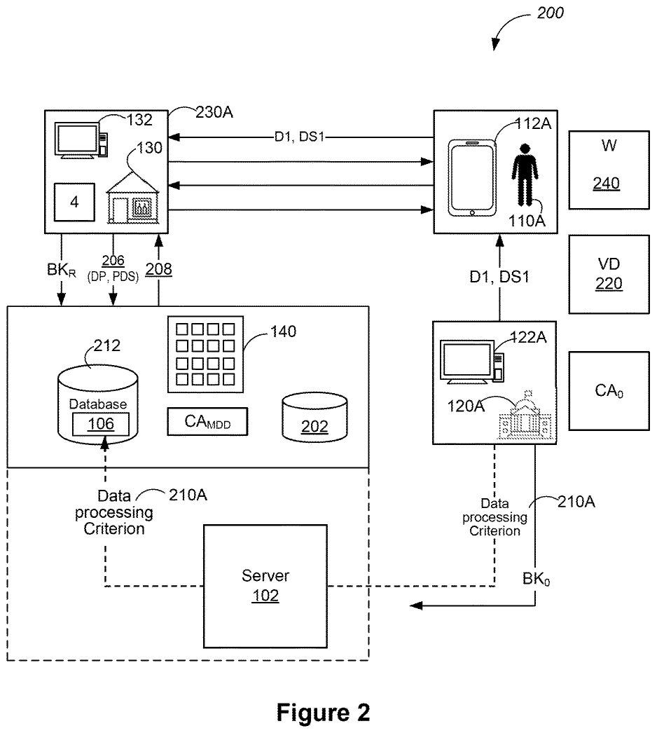

FIG. 2 is a flow diagram of an example process 200 of verifying user data 108 on a multi-user DVP 100, in accordance with some embodiments. The DVP 100 is configured to verify the user data 108 of individual users 110 via a server 102 and electronic devices 112, 122, and 132 corresponding to the individual users 110, origin entities 120, and organization users 130, respectively.

In some embodiments, an organization user 130 (e.g., a liquor store) utilizes user data, digital signature, and metadata to determine how to respond to a request of an individual user 110. The user data and the metadata are officially issued by an origin entity (e.g., a bank, a credit card company, a government branch). In an example, the user data and metadata are included in a digital driver's license issued by a Department of Motor Vehicles (DMV). Supplemental metadata 106 used by the organization user 130 are also provided a server 102 associated with a metadata distributor 140. The metadata distributor 140 may own the server 102 or may be a contractor of an owner of the DVP 100 who owns the server 102. The organization user 130 needs to have confidence in user data about the individual user. The user data critical to decision making are issued by a trusted origin entity 120. Reliability or trustworthiness of the user data is inferred from the metadata 106 including additional quality indicators, metrics, characteristics of the user data. In an example, an age of an individual user 110 is important when an organization user 130 is selling alcohol; the organization user 130 may infer the age from a driver license presented by the organization user 130, and may gain confidence in the age data by examining the security characteristics of the license, checking that the photograph on the license matches the organization user 130, and checking if the issuer of the license is recognized. In electronic commerce systems, issuers of a trustworthy license (e.g., origin entity 120) can be listed in an official register.

Some implementations are directed to a data verification platform (DVP) 100 that is configured to verify individual users' sensitive user data 108, which are issued by origin entities 120, based on associated metadata 106. The user data 108 are collected from the individual users 110 by the organization users 130, thereby allowing the organization users 130 to operate based on the sensitive user data in a trustworthy manner. In some embodiments, origin entities in the DVP may remain complete strangers to organization users 130 and still be trusted. In some instances, organization users 130 may not need local legislation to legitimize foreign data for use by organization users 130, because metadata distributors 140 may be configured to programmatically and/or automatically understand the terms and conditions of user data and metadata 106 provided to the DVP. For example, there may be a digital age verification via mobile (e.g., digital) driver licenses used by retailers of age-restricted goods and services to screen shoppers. Many drivers licensing authorities are state-based, and thus their digital proofs of age may be natively confined to a relatively small jurisdiction where respective state legislation is in force. This limitation stems only partially from narrowness of legislation. Legislation is not sufficient to make credentials acceptable to retailers. Even if legislation is enacted in the state where a retailer does business to legitimize digital proof of age from other states, the retailer's e-commerce server may also need to be configured with the root keys of all legitimate credential issuers so it can verify the digital signature on each proof. In some instances, the DVP 100 is configured to perform the verification of the digital signature 118 on the proof such that data from the origin entity 120, including origin entities 120 that are distant or remote, is made clear and easy for an organization user to understand. In some instances, one or more origin entities 120 may be participants in the DVP 100.

In an example, an organization user 130 may be an online liquor retailer, and an individual user 110 requests an age-sensitive transaction with the online liquor retailer. The user data 108 includes an age of the individual user 110. A trusted origin entity 120 may be a Department of Motor Vehicles (DMV), which issues a driver's license including age information. The server 102 provides a data verification application 104 to the organization user 130, the origin entity 120, and the data verification application 104 is executed to verify the user data 108 for the organization user 130 on behalf of the origin entity 120. The user data 108 may include one or more of: an age, an account number, transaction data, an email address, an age of an email address, a password, and a flag indicating a personal status of an individual user that is embedded in a digital signature 118 generated using an origin private key of an origin entity 120. The DVP 100 is a combination of networks, databases, and other subsystems that facilitate exchange of user data 108 and metadata 106 among the server 102 and electronic devices associated with the individual users 110, the origin entities 120, and the organization users 130. More details on some embodiments associated with age verification are discussed below in “Supplemental Information and Alternative Embodiments,” so are additional embodiments on push payment payee verification are discussed.

In some embodiments, the server 102 includes, or is coupled to, a metadata database 212 configured to store metadata 106 of the origin entities 120 and the organization users 130. An electronic device 122A of a first origin entity 120A may issue user data 108 of individual users 110 (e.g., first user data D1) with digital signatures 118 (e.g., first digital signature DS1) in a digital format, and provide the metadata 106 (e.g., description of user data, guidance on how to process user data) to the sever 102. An electronic device 132 may provide supplemental metadata 106 associated with the user data 108) to the server 102 as well.

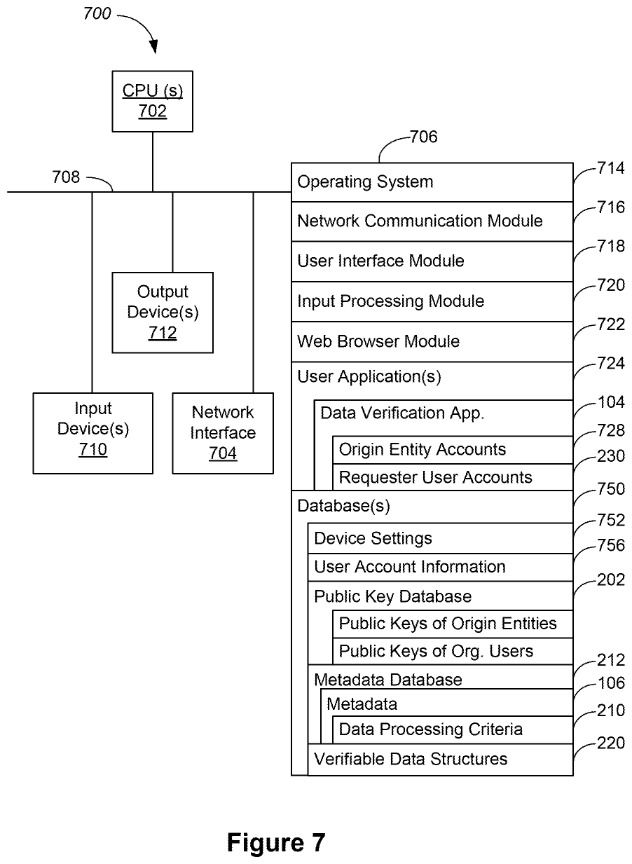

The server 102 includes, or is coupled to, a public key database 202 configured to store a plurality of origin public keys BK_{O} of the origin entities 120 and a plurality of requester public keys BK_{R} of the organization users 130. The server 102 receives the plurality of origin public keys BK_{O} from the origin entities 120 and stores the origin public keys BK_{O} in the public key database 202. Each of a plurality of origin entities 120 has a respective origin public key BK_{O} corresponding to a set of user data 108 issued by the respective origin entity 120 to a subset of the plurality of individual users 110. A subset of the metadata 106 stored in the metadata database 212 corresponds to the set of user data provided by each origin entity. The server 102 receives the plurality of requester public keys BK_{R} from a plurality of requester accounts of the organization users 130 and stores the requester public keys BK_{R} in the public key database 202. For each of the plurality of requester accounts, the respective requester public key BK_{R} is used to verify data received from the respective requester account. In some implementations, the public key database 202 may be distinct from the metadata database 212. In some implementations, the public key database 202 and the metadata database 212 belong to a database (e.g., database 750 in FIG. 7).

In an example, the server 102 manages age verification for liquor stores in one or multiple countries based on different government identifications issued by a plurality of jurisdictions. These jurisdictions apply their own rules on liquor buying, while the liquor stores have to apply local rules as well. The metadata 106 includes information concerning these rules and related information needed to apply these rules. The DVP is configured to collect the metadata 106 from government branches issuing the identifications and liquor stores enforcing the local rules, and manage the metadata 106 in the metadata database 21.

The server 102 receives, from a first requester account 230A, a data verification request 206 including payload data DP and a payload digital signature PDS associated with the payload data DP, and the payload data DP further includes first user data D1 of a first individual user 110A and a first digital signature DS1 associated with the first user data D1. In response to the data verification request 206, the server extracts, from the public key database 202 a requester public key BK_{R} associated with the first requester account 230A and applies the requester public key BK_{R} to verify whether the payload data DP, received from the first requester account 230A, are generated by the first requester account 230A. In accordance with a verification of the payload data DP, the server 102 identifies a first origin entity 120A that has issued the first user data D1 of the first individual user 110A based on the payload data DP, and extracts, from the public key database 202, the origin public key BK_{O} associated with the first origin entity 120A. The server 102 applies the origin public key BK_{O} to verify whether the first user data D1, received via the first requester account 230A, are issued by the first origin entity 120A.

In some embodiments, the data verification request 206 includes an identifier of the first origin entity 120A providing the first digital signature DS1 of the first user data D1. The public key database 202 stores a list of identifiers associated with authorized origin entities 120, and the public key database 202 is searched for a match with the identifier of the first origin entity 120A. In some embodiments, the server 102 obtains an identifier of the first requester account 230A, and searches a list of identifiers associated with authorized requester accounts for the identifier of the first requester account 230A.

In some embodiments, in accordance with a verification that the first user data D1 are issued by the first origin entity 120A, the server 102 generates a message 208 associated with the first individual user 110A based on the first user data D1 and a subset of the metadata 106. The subset of the metadata is associated with the first user data and provided by the first origin entity. The message 208 is provided to the first requester account 230A, and may include one or more of: the first user data D1, a confirmation indicating that the first user data D1 comply with a first data processing criterion 210A, and a confirmation indicating that the first user data D1 does not comply with the first data processing criterion 210A. Further, in some embodiments, upon the verification, the first requester account 230A further determines whether the first user data D1 complies with one or more local data processing criteria. More specifically, in some embodiments, the metadata 106 stored in the metadata database 212 include data processing criteria 210 associated with different origin entities 120 and/or local organization users 130 (e.g., criterion 210A of the first origin entity 120A). Each data processing criterion 210 sets requirements for using a set of user data 108 issued by a respective origin entity 120 to a subset of the plurality of individual users 110. Upon verifying the first digital signature DS1, the sever 102 extracts a first data processing criterion 210A from the metadata database 212, and applies the first data processing criterion 210A to the first user data D1 associated with the first individual user 110A to generate a confirmation message 208 indicating whether the first user data D1 satisfy the first data processing criterion 210A. In some embodiments, the server 102 extracts an additional data processing criterion set by another entity or organization user 130 which has a jurisdiction, and applies the additional data processing criterion to the first user data D1 as well.

For example, the DVP 100 receives the first user data D1 of a digital driver's license of a first person 110A from a liquor store. The DVP confirms that the first user data D1 of the digital driver's license is indeed issued by a DMV based on a first digital signature DS1 issued by the DMV with the digital driver's license. The DVP then extracts the metadata 106 associated with the digital driver's license, and the metadata 106 includes information concerning liquor purchasing, e.g., the minimum age to buy liquor products in the DMV's state, whether the first user 110A has a driving under the influence (DUI) history or a pending DUI charge. The DVP 100 may extract supplemental metadata 106 associated with the liquor store, e.g., the minimum age to buy liquor products in the store's state. After verifying a source of the first user data D1, the DVP 100 reviews the first user data D1 (e.g., age information of the first user 110A) based on the associated metadata 106.

In some embodiments, during data verification, the server 102 stores the first user data D1 and the first digital signature DS1 of the first user data 110A temporarily in its memory, and after sending the message 208 in response to the data verification request 206, purges the first user data D1 and the first digital signature DS1 of the first user data D1 from the memory. Stated another way, in some implementations, the server 102 does not store the first user data D1 including personal information of the first individual user 110A by itself, and only stores the origin public key BK_{O} of the first origin entity 120A and the associated metadata 106 set by the origin entity 120A or the organization user 130 for verifying the first user data D1 ad hoc upon request. By these means, the server 102 does not need to maintain a large database that requires a high level of security, thereby conserving storage and computational resources, while maintaining a capability of promptly responding to any data verification request.

Examples of the metadata 106 include, but are not limited to:
a validity data range for the first user data D1 (e.g., an age range);
a type of credential holder, where an origin entity 110A has a control over how a credential is carried, where in some embodiments, a driver's license is only carried on a specific type of smartcard;
machine-readable indicator of an intended application of a credential, where in some embodiments, the indicator includes a link to a data processing criterion 210A, which is incorporated by reference via the metadata 106; and
a value of associated with the indicator that is used by the data verification application to check whether the first user data D1 is fit for purpose, wherein in some embodiments, the first user data D1 associated with a proof of age may be issued by different state government bureaus and include values that are mapped to respective state government regulations for age proofing.

In some embodiments, the first user data D1 is issued with the first digital signature DS1 to the first individual user 110A. An electronic device 112A associated with the first individual user 110A may execute a digital wallet application 240 to store the first user data D1 with the first digital signature DS1. The first user data D1 may include personal information of the first individual user 110A (e.g., age information) that is embedded in the first digital signature DS1. In some situations, the personal information of the first individual user 110A has an encrypted format, when the first user data D1 is received and stored in a mobile device 112A associated with the first individual user 110A, and the personal information is not readable from a user interface of the digital wallet application 240. Nor is the personal information readable by the first organization user 130A. Upon verifying the payload digital signature PDS and the first digital signature DS1, the server 102 decrypts the first user data D1 to extract the personal information. More details on digital wallet are discussed below in “Supplemental Information and Alternative Embodiments.”

In some embodiments, the first user data D1 is issued in a verifiable data (VD) structure 220. The verifiable data structure includes one or more of: an identifier of the first individual user, first user data D1, user metadata including a data processing criterion associated with the first user data, an individual public key, an identifier of the first origin entity, a digital signature of the first origin entity, and a signature parameter of the digital signature of the first origin entity 120A. The verifiable data structure of the first user data D1 may be sent jointly to a mobile device 112A associated with the first individual user 110A.

In some embodiments, the server 102 manages cryptographic practice for the individual users 110, the origin entities 120, and the organization users 130. For example, the server 102 distributes, to each of the individual users 110, origin entities 120, and organization users 130, a respective public key and an associated private key used to generate a respective digital signature (e.g., the first digital signature DS1).

It is noted that the DVP 100 is not limited to manage critical data (e.g., age information) issued by a government agency. In some embodiments, the DVP 100 is applied by financial entities to manage critical data related to financial transactions. More details on an onboarding flow associated with virtual band cards and mobile wallets are discussed below in “Supplemental Information and Alternative Embodiments.” In these financial applications, the onboarding flow involves card presentation, onboarding verifiable data structure.

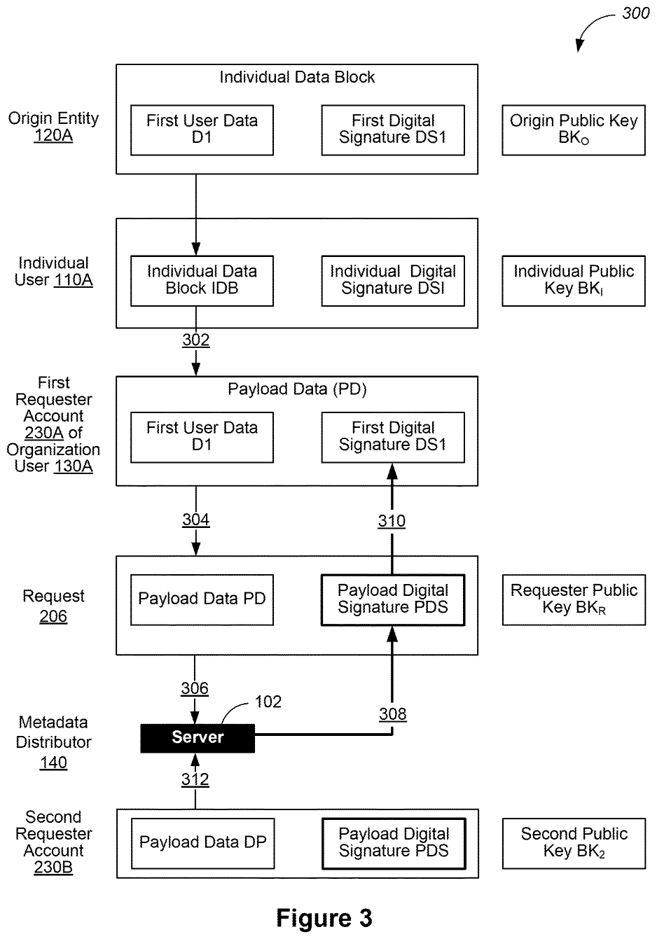

FIG. 3 is a flow diagram of an example process 300 of managing first user data D1 in data verification, in accordance with some embodiments. A server 102 executes a data verification application 104 (FIG. 1) for verifying user data 108 of a plurality of individual users 110 on behalf of a plurality of origin entities 120. The data verification application 104 is coupled to a public key database 202 (FIG. 2) that stores, for each of a plurality of origin entities 120, a respective origin public key BK_{O} corresponding to a set of user data 108 issued by the respective origin entity 120 to a subset of the plurality of individual users 110. For example, the public key database 202 stores an origin public key BK_{O} for a first origin entity 120A. For data verification, an electronic device 132 of a first organization user 130A obtains (operation 302) first user data D1 from an electronic device 112A of a first individual user 110A, and generates (operation 304) a data verification request 206 including payload data DP and a payload digital signature PDS associated with the payload data DP. The payload data DP further includes first user data D1 of a first individual user 110A and a first digital signature DS1 associated with the first user data D1. The server 102 receives (operation 306) the data verification request 206 from a first requester account 230A of the first organization user 130A

In response to the data verification request 206, the server extracts, from the public key database 202, a requester public key BK_{R} associated with the first requester account 230A of the first organization user 130A. The payload digital signature PDS associated with the payload data DP is decrypted (operation 308) using the requester public key BK_{R} associated with the first requester account 230A to generate a decrypted payload digital signature PDS. Based on the decrypted payload digital signature PDS, the server 102 verifies whether the payload data PD, received from the first requester account 230A, are generated by the first requester account 230A.

In some embodiments, in accordance with a verification of the payload data PD, the server 102 extracts the first digital signature DS1 and the first user data D1 of the first individual user 110A from the payload data PD. The sever identifies the first origin entity 122A that has issued the first user data D1 of the first individual user 110A based on the payload data PD, and extracts, from the public key database 202, the origin public key BK_{O} associated with the first origin entity 120A. The first digital signature DS1 associated with the first user data D1 may be decrypted (operation 310) using the origin public key BK_{O} associated with the first origin entity 120A to generate a decrypted first digital signature DS1. Based on the decrypted first digital signature DS1, the server 102 verifies whether the first user data D1, received via the first requester account 230A, are issued by the first origin entity 120A. More details on an associated presentation process of an individual user 110 on the DVP are discussed below in “Supplemental Information and Alternative Embodiments.”

It is noted that, in some embodiments, the server 102 determines whether the first requester account 230A is an authorized user of the data verification application 104 prior to decrypting the first digital signature DS1. Stated another way the first digital signature DS1 is decrypted using the origin public key BK_{O}, in accordance with a verification of the payload data PD and a verification that the first requester account 230A is the authorized user of the data verification application 104. In some embodiments, the data verification request 206 includes an identifier of the first requester account 230A. The DVP stores a list of identifiers associated with authorized requester accounts, and the public key database 202 is searched for a match with the identifier of the first requester account 230A. The server 102 obtains the identifier of the first requester account 230A, and searches the metadata including the list of identifiers associated with authorized requester accounts for the identifier of the first requester account 230A.

In some embodiments, verification of the first digital signature DS1 (operation 310) is based on verification of the payload digital signature PDS, thereby enhancing data security. For example, in some situations, the payload data PD and the payload digital signature PSD are intercepted by a second requester account 230B. The server 102 receives (operation 312), from the second requester account 230B, a second verification request including the payload data DP and the payload digital signature PDS, and verifies the second requester account 230B for reviewing the payload data PD. The server 102 may extract, from the public key database 202, a second public key BK₂ associated with the second requester account 230B, and decrypt the payload digital signature PDS associated with the payload data PD using the second public key BK₂ associated with the second requester account 230B to generate a second decrypted signature. Given that the second public key BK₂ was not used to generate the payload digital signature PDS, the server 102 may verify that the second requester account 230B does not sign the payload data PD based on the second decrypted signature. The server 102 may determine that the second requester account 230B is not an authorized user of the data verification application 104. The server 102 therefore aborts decrypting the first digital signature DS1 of the first user data D1 associated with the first individual user 110A with the origin public key BK_{O}.

Further, in some embodiments, a mobile device 112 associated with an individual user 110 generates an individual digital signature DSI associated with an individual data block IDB using an individual private key VK_{I}. The individual data block IDB includes the first user data D1 and the first digital signature D1 issued by the first origin entity 120A. The mobile device 112 associated with the individual user 110 sends the individual digital signature DSI and the individual data block IDB to the electronic device 132A associated with the first requester account 230A having an individual public key BK_{I} provided by the mobile device 112. The electronic device 132A processes the individual digital signature IDS using the individual public key BK_{I} to verify that the mobile device 122, sending the individual data block IDB, generates the individual digital signature DSI. In accordance with a verification of the mobile device 112, the first requester account 230 generates the data verification request 206 including the payload digital signature PDS based on the requester private key BK_{R}.

In some embodiments, the server 102 manages cryptographic practice for the plurality of origin entities 120 and the plurality of organization users 130. For example, the server 102 provides, to each of the plurality of origin entities 120, the respective origin public key BK_{O} and an associated origin private key VK_{O} configured to create the first digital signature DS1 by the respective origin entity 120. In some embodiments, the server 102 provides, to each of the plurality of organization users 130, the respective requester public key BK_{R} and an associated requester private key VK_{R} used to create payload digital signature DSP by the first requester account 230A associated with the first organization user 130A. In some embodiments, the server 102 provides, to each of the plurality of individual users 110, the respective individual public key BKI and an associated requester individual key VK_{I} used to create an individual data block IDB by a mobile device of the first individual user 110A.

In some embodiments, a verifiable credential is a combination of first user data DS1, an identifier of a user, metadata 106 (e.g., data processing criterion 210A), an individual public key, and a first digital signature DS1. More details on credential issuance, verification of origin entities 120, verification of organization users 130, and verifiable credentials are discussed below in “Supplemental Information and Alternative Embodiments.”

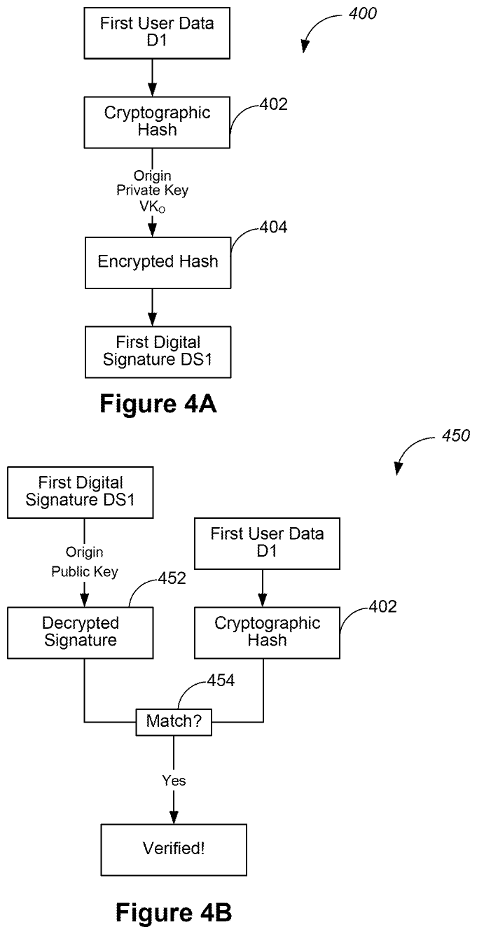

FIG. 4A is a flow diagram of an example process 400 of a first digital signature DS1 of first user data D1, in accordance with some embodiments, and FIG. 4B is a flow diagram of an example process 450 of verifying a first digital signature DS1 of first user data D1, in accordance with some embodiments. The first digital signature DS1 is generated by an electronic device 122 associated with an origin entity 120 using an origin private key VK_{O}. For example, a Secure Hash Algorithm (SHA) is applied to generate the first digital signature DS1 based on Rivest-Shamir-Adleman (RSA) encryption. Referring to FIG. 4A, in some embodiments, the electronic device 122 obtains a key pair consisting of an origin private key VK_{O} and a corresponding origin public key PK_{O}. The origin private key VK_{O} is used to sign the first user data D1 (e.g., generate the first digital signature DS1), while the origin public key PK_{O} is used to verify the first digital signature DS1. The electronic device 122 creates a cryptographic hash 402 of the first user data D1 (e.g., using SHA256RSA), and the cryptographic hash 402 is a unique representation of the first user data D1. The cryptographic hash 402 is encrypted by the origin private key VK_{O} to generate an encrypted hash 404, which is applied as the first digital signature DS1 of the first user data D1.

The first user data D1 may be issued with the first digital signature DS1 to the first individual user 110A. An electronic device 112A associated with the first individual user 110A may execute a digital wallet application 240 (FIG. 2) to store the first user data D1 with the first digital signature DS1. The first user data D1 may include personal information of the first individual user 110A (e.g., age information) that is embedded in the first digital signature DS1 generated using a private key VK_{O} of the first origin entity 120A. In some embodiments, the electronic device 112A presents the first user data D1 and the first digital signature DS1 to the first organization user 130A. The first user data D1 and the first digital signature DS1 are transferred from the electronic device 112A to an electronic device 132A of the first organization user 130A. In some situations, the electronic device 132A associated with the first requester account 230A executes the data verification application 104 and imports the first digital signature DS1 of the first user data D1 from the digital wallet application 240 of the electronic device 112A (e.g., a mobile device). The electronic device 132A of the first organization user 130A may further generate payload data PD including the first user data D1 and the first digital signature DS1, and create payload digital signature PDS for the payload data PD using a requester private key VK_{R}, e.g., using SHA256RSA. The electronic device 132A sends the payload data PD and the payload digital signature PDS to the server 102 via a data verification request 206.

Referring to FIG. 4B, in some embodiments, the server 102 obtains the origin public key BK_{O} and decrypts the first digital signature DS1 of the first user data D1 using the origin public key BK_{O} to generate a decrypted first digital signature 452. The server 102 regenerates the cryptographic hash 402 of the first user data D1 and compares (operation 454) the decrypted first digital signature 452 with the cryptographic hash 402. In accordance with a determination that the decrypted first digital signature 452 matches the cryptographic hash 402, the server 102 verifies that the first user data D1 are issued by the first origin entity 120A.

Upon receiving the data verification request 206 from the requester user account 230A, the server 102 may verify the payload data DP before it verifies the first user data D1. The server 102 obtains the requester public key VK_{O} and decrypts the payload digital signature PDS of the payload data PD using the requester public key VK_{O} to generate a decrypted payload digital signature. The server 102 regenerates a cryptographic hash of the payload data PD and compares the decrypted payload digital signature with the cryptographic hash of the payload data PD. The server 102 verifies that the payload data PD is issued by the requester user account 230A based on a comparison result. Upon a verification of the payload data, the first user data D1 and the first digital signature DS1 are extracted from the payload data DP, and verified as shown in FIG. 4B.

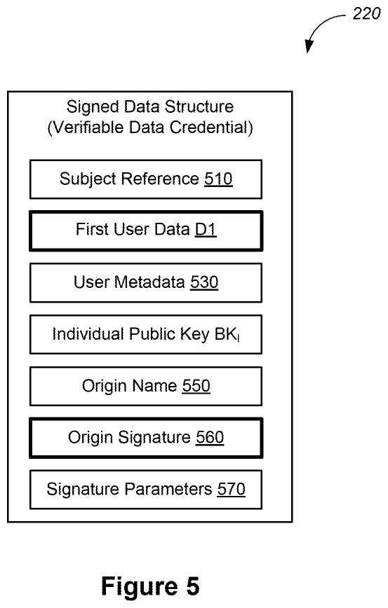

FIG. 5 is a block diagram of an example verifiable data structure 220 of first user data D1, in accordance with some embodiments. The verifiable data structure includes one or more of: an identifier of the first individual user 510, first user data D1, user metadata 106 including a data processing criterion 210A associated with the first user data D1, an individual public key BK_{I}, an identifier of the first origin entity 120A, a first digital signature DS1 of the first origin entity 120A, and a signature parameter of the digital signature DS1 of the first origin entity 120A. The verifiable data structure 220 of the first user data D1 may be sent jointly to a mobile device 112A associated with a first individual user 110A. In an example, the first user data D1 includes age information of the first individual user 110A. In an example, the first origin entity 120A establishes the age of the first individual user 110A according to a set of age verification criteria and issues a mobile device associated with the first individual user 110A with a verifiable data structure 220 as a proof of age. The verifiable data structure 220 may include metadata that may indicate or reference the age verification criteria so that any organization user using the verifiable data structure 220 can determine whether the criteria 210 are compatible with the organization user's business requirements or in other words if the verifiable data structure 220 is fit for purpose. In some embodiments, a public key infrastructure (PKI) application features an example of such metadata as a policy identifier that codifies the verification criteria applied in issuing a PKI certificate.

In some embodiments, a database stores a data processing criterion 210A associated with the first user data D1, an individual public key BK_{I}, an identifier of the first origin entity 120A, a first digital signature DS1 of the first origin entity 120A, and a signature parameter of the digital signature DS1 of the first origin entity 120A.

In some embodiments, the verifiable data structure 220 of first user data D1 includes one or more of:
Identifier 510 of the first individual user 110A, e.g., a human first individual user 110A's name, a pseudonym, customer reference number or other identifier;
First user data D1, e.g., age, a flag representing that the first individual user 110A is at least as old as a legislated age limit of interest;
User metadata 530 relating to the rules under which the first user data D1 was verified and/or conditions for use of the verifiable credential.
Individual Public Key BK_{I} corresponding to a private key held in a digital wallet application 240 of the first individual user 110A, where presentation of the first individual user's credential may be signed using an individual private key VK_{I} and verified using the individual public key BK_{I}.
Origin entity name 550.
Origin signature 560 (e.g., the first digital signature DS1) applied to the verifiable credential using an origin private key VK_{O} controlled by the first origin entity 120A in accordance with a public key cryptography method; and
Signature parameters 570, e.g., an algorithm used by an organization user 130 or other party to guide a verification of the origin signature 560.

A credentialing process is applied to prepare participants (e.g., users 110, 120, and 130, distributors 140) to process user data with a verifiable data structure 220. More details on a credentialing process on the DVP are discussed below in “Supplemental Information and Alternative Embodiments.”

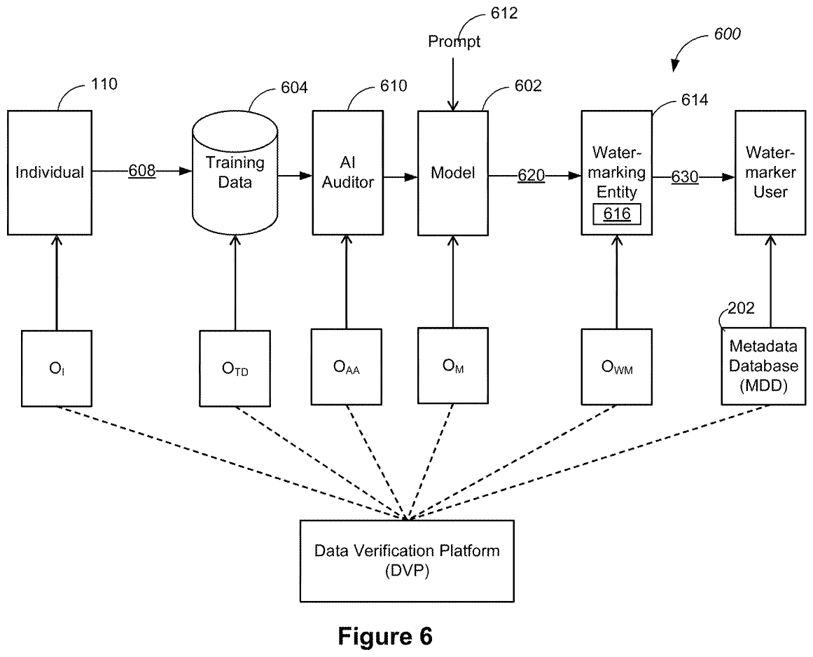

FIG. 6 is a block diagram illustrating an example data verification environment 600 in which artificial intelligence is used to watermark user information, in accordance with some embodiments. Generative artificial intelligence (GAI) systems are configured to produce images and written works (e.g., a digital object 620) that are difficult to differentiate from works of human creators. GAI outputs may be watermarked to combat counterfeiting and intellectual property theft. A watermark is a digital signature or similar cryptographic code generated by a public key cryptographic transformation of the AI-generated digital object 620. The digital object 620 may be associated with a watermark object that is configured to be verified using a trusted public key associated with a watermarking process. The data verification environment 600 provides a solution to understand and interpret watermarks associated with a GAI-based digital object 620 through an intermediary metadata distributor 140 (FIG. 1).

In some embodiments, a GAI model 602 operates on a set of training data 604 which has been sourced from a number of individual users 110. An individual user 110 gives a consent 608 of using data for training the GAI model 602. Prior to training, the training data 604 is audited by an AI Auditor 610 to provide assurance that the data satisfies relevant ethics and quality standards. The model 602 receives a prompt 612 to generate a digital object 620, and generates the digital object 620. The digital object 620 is watermarked by a watermarking entity 614, i.e., the watermark entity 614 generates a watermark 616 associated with the digital object 620. The watermark 616 is a type of public key signature. The digital object 620 and watermark 616 form a watermarked object 630. Administrative information about the watermarking entity 614 (including the nature of the entity's authority to apply watermarks) is contained in a verifiable credential (not shown) issued by an origin entity O_{WM}. Subsequently, the watermarked object 630 is sent to a user 110.

The watermark 616 is verified using metadata 106 including public keys by a server 102 associated with a metadata distributor 140. The server 102 is configured to interpret the watermark 616 based on information of the origin entity 120 facilitating watermarking, a jurisdiction, and any terms and conditions (e.g., data processing criteria 210) applied by the watermarking process. There are numerous stages in the data processing chain of events involved in AI where metadata 106 can be important. In some embodiments, the present invention provides the means to secure the metadata 106 along the data processing chain by enabling different processing entities to sign intermediate digital objects in a verifiable manner. More details on generating a digital signature of a digital object (e.g., first user data D1) is explained above with reference to FIGS. 4A and 4B.

Different processing entities are supported by verifiable origin entities. An origin entity 120 issues, to an individual user 110, a verifiable credential O_{I}, which is used to sign the data provided to the training set 604 and indicate the consent 608. The origin entity issues, to a custodian of training data 604, a verifiable credential OTD, which is used to sign and brand the data before they are used in the model 602. The origin entity issues, to the AI Auditor 610, a verifiable credential O_{AA}, which is used to sign the audited data so that the audited data is distributed with a proof of compliance. The origin entity issues, to the entity running the AI Model 602, a verifiable credential O_{M}, which is used to prove matters of interest (e.g., a precise algorithm and parameters used to create the object 620). Further, in some embodiments, the origin entities 120 and metadata distributors 140 are joined contractually to the DVP 100, e.g., based on one or more respective data processing criteria 210. The DVP 100 simplifies verification of watermarks across a global AI ecosystem.

More details on some embodiments associated with a watermarking generative artificial intelligence application are discussed below in “Supplemental Information and Alternative Embodiments,”

FIG. 7 is a block diagram illustrating a representative computing system 700, in accordance with some embodiments. The computing system 700 is configured to manage metadata (e.g., public keys) of a plurality of origin entities and organization users and verifying user data, of individual users, issued by these origin entities using the metadata in response to requests received from registered user accounts of the organization users. The computing system 700 typically, includes one or more processing units (CPUs) 702, one or more network interfaces 704, memory 706, and one or more communication buses 708 for interconnecting these components (sometimes called a chipset). The computing system 700 includes one or more input devices 710 that facilitate user input, such as a keyboard, a mouse, a voice-command input unit or microphone, a touch screen display, a touch-sensitive input pad, a gesture capturing camera, or other input buttons or controls. In some implementations, the computing system 700 includes one or more optical cameras (e.g., an RGB camera), scanners, or photo sensor units for capturing images. The computing system 700 also includes one or more output devices 712 that enable presentation of user interfaces and display content, including one or more speakers and/or one or more visual displays.

Memory 706 includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. Memory 706, optionally, includes one or more storage devices remotely located from one or more processing units 702. Memory 706, or alternatively the non-volatile memory within memory 706, includes a non-transitory computer readable storage medium. In some implementations, memory 706, or the non-transitory computer readable storage medium of memory 706, stores the following programs, modules, and data structures, or a subset or superset thereof:
Operating system 714 including procedures for handling various basic system services and for performing hardware dependent tasks;
Network communication module 716 for connecting each server 102 or electronic device 112, 122, or 132 to other devices (e.g., server 102, electronic device 112, 122, or 132, or storage 116) via one or more network interfaces 704 (wired or wireless) and one or more communication networks 124, such as the Internet, other wide area networks, local area networks, metropolitan area networks, and so on;
User interface module 718 for enabling presentation of information (e.g., a graphical user interface for application(s) 724, widgets, websites and web pages thereof, and/or games, audio and/or video content, text, etc.) at each electronic device 112, 122, or 132 via one or more output devices 712 (e.g., displays, speakers, etc.);
Input processing module 720 for detecting one or more user inputs or interactions from one of the one or more input devices 710 and interpreting the detected input or interaction;
Web browser module 722 for navigating, requesting (e.g., via HTTP), and displaying websites and web pages thereof, including a web interface for logging into a user account associated with an electronic device 112, 122, or 132 or another electronic device, controlling the electronic device 112, 122, or 132 if associated with the user account, and editing and reviewing settings and data that are associated with the user account;
One or more user applications 724 for execution by the computing system 700, including a data verification application 104 that has a plurality of user accounts 728 and 230 associated with a plurality of origin entities 120 and organization users 130, where in some embodiments, the data verification application 104 is configured to manage metadata 106 (e.g., public keys) associated with the plurality of user accounts 728 and 230 and verify user data 108 (FIG. 1), of individual users 110, issued by these origin entities 120 using the metadata 106 in response to requests received from a subset of registered requester accounts 230 of the organization users 130; and
One or more databases 750 for storing at least data including one or more of:
   Device settings 752 including common device settings (e.g., service tier, device model, storage capacity, processing capabilities, communication capabilities, etc.) of the computing system 700;
   User account information 756 associated with the plurality of user accounts 728 and 230 for the one or more user applications 724 (e.g., user names, security questions, account history data, user preferences, and predefined account settings); and
   Public key database 202 for storing at least origin public keys BK_{O} of origin entities 120 and requester public keys BK_{R} of organization users 130;
   Metadata database 212 for storing metadata 106 collected from individual users 110, origin entities 120, and/or organization users 130, where in some embodiments, the metadata 106 include data processing criteria 210 applicable to different types of user data 108; and
   Verifiable data structures 220 that are received from the plurality of user accounts 728 and 230 and include at least the user data 108 (e.g., first user data D1) to be verified and associated digital signatures 118 (e.g., first digital signature DS1).

In some embodiments, the computing system 700 includes one or more servers 102 that execute a server-side data verification application 104, which is configured to manage collection of the metadata (e.g., public keys) of the origin entities 120 and organization users and verify user data 108 of individual users 110 provided by the organization users 130. In some embodiments, the computing system 700 includes electronic devices each of which is a desktop computer, a laptop computer, a tablet computer, a smart phone, a point-of-sale device, or any other computing device. Each electronic device has at least a processor capable of executing a client-side data verification application for an origin entity 120 or an organization user 130 to manage respective metadata 106 and/or request verification of user data 108 of a certain individual user 110. The user data 108 are communicated among the server system 102 and electronic devices 112, 122, and 132 of an origin entity 120, an organization user 130, and an individual user 110 in a verifiable data structure 220.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various embodiments. In some implementations, memory 706, optionally, stores a subset of the modules and data structures identified above. Furthermore, memory 706, optionally, stores additional modules and data structures not described above.

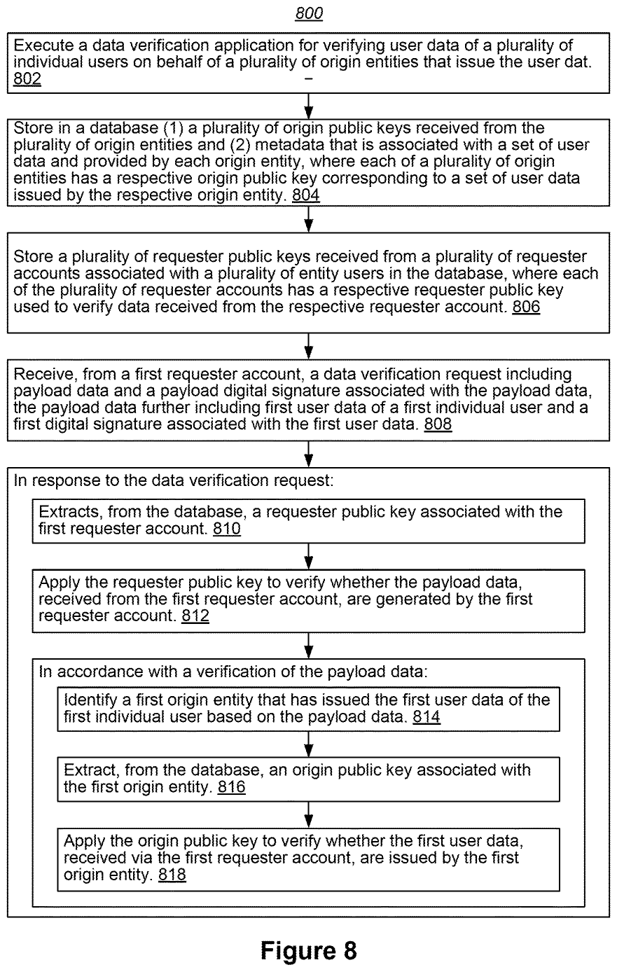

FIG. 8 is a flow diagram of an example method 800 of verifying user data, in accordance with some embodiments. In some embodiments, the method is applied in a server system. For convenience, the method 800 is described as being implemented by a computing system 700 (FIG. 7). Method 800 is, optionally, governed by instructions that are stored in a non-transitory computer readable storage medium and that are executed by one or more processors of the computing system 700. Each of the operations shown in FIG. 8 may correspond to instructions stored in a computer memory or non-transitory computer readable storage medium (e.g., memory 714 of the computing system 700 in FIG. 2). The computer readable storage medium may include a magnetic or optical disk storage device, solid state storage devices such as Flash memory, or other non-volatile memory device or devices. The instructions stored on the computer readable storage medium may include one or more of: source code, assembly language code, object code, or other instruction format that is interpreted by one or more processors. Some operations in method 800 may be combined and/or the order of some operations may be changed.

In accordance with some implementations of this application, a computing system 700 (e.g., a server 102) executes (operation 802) a data verification application 104 for verifying user data of a plurality of individual users 110 on behalf of a plurality of origin entities 120, which issue the user data. The computing system 700 stores (operation 804) a plurality of origin public keys received from the plurality of origin entities 120 and metadata 106 that is associated with a set of user data and provided by each origin entity 120 in a database 750. Each of a plurality of origin entities 120 has a respective origin public key corresponding to a set of user data issued by the respective origin entity to a subset of the plurality of individual users 110. The computing system 700 stores (operation 806) a plurality of requester public keys received from a plurality of requester accounts 230 associated with a plurality of entity users in the database 750. Each of the plurality of requester accounts 230 has a respective requester public key used to verify data received from the respective requester account 230. The computing system 700 receives (operation 808), from a first requester account 230A, a data verification request 206 including payload data PD and a payload digital signature PDS associated with the payload data PD. The payload data PD further includes first user data D1 of a first individual user 110A and a first digital signature DS1 associated with the first user data D1.

In response to the data verification request 206, the computing system 700 extracts (operation 810), from the database 750, a requester public key associated with the first requester account 230A, and applies (operation 812) the requester public key to verify whether the payload data PD, received from the first requester account 230A, are generated by the first requester account 230A. In accordance with a verification of the payload data PD, the computing system 700 identifies (operation 814) a first origin entity 120A that has issued the first user data D1 of the first individual user 110A based on the payload data PD, extracts (operation 816), from the database 750, an origin public key BK_{O} associated with the first origin entity 120A, and applies (operation 818) the origin public key BK_{O} to verify whether the first user data D1, received via the first requester account 230A, are issued by the first origin entity 120A.

In accordance with some implementations of this application, a computing system 700 (e.g., a server 102) executes (operation 802) a data verification application 104 for verifying user data of a plurality of individual users 110 on behalf of a plurality of origin entities 120. The data verification application 104 is coupled to a database 750 that stores, for each of a plurality of origin entities 120, (1) a respective origin public key corresponding to a set of user data issued by the respective origin entity to a subset of the plurality of individual users 110 and (2) metadata 106 that is associated with the set of user data and provided by the respective origin entity 120. The computing system 700 receives (operation 808), from a first requester account 230A, a data verification request 206 including payload data PD and a payload digital signature PDS associated with the payload data PD. The payload data PD further includes first user data D1 of a first individual user 110A and a first digital signature DS1 associated with the first user data D1.

In response to the data verification request 206, the computing system 700 extracts, from the database 750, a requester public key associated with the first requester account 230A, decrypts the payload digital signature PDS associated with the payload data PD using the requester public key associated with the first requester account 230A to generate a decrypted payload digital signature PDS, and based on the decrypted payload digital signature PDS, verifies whether the payload data PD, received from the first requester account 230A, are generated by the first requester account 230A. In accordance with a verification of the payload data PD, the computing device obtains the payload data PD including the first digital signature DS1 and the first user data D1 of the first individual user 110A, identifies a first origin entity 120A that has issued the first user data D1 of the first individual user 110A based on the payload data PD, extracts, from the database 750, an origin public key BK_{O} associated with the first origin entity 120A, decrypts the first digital signature DS1 associated with the first user data D1 using the origin public key BK_{O} associated with the first origin entity 120A to generate a decrypted first digital signature DS1, and based on the decrypted first digital signature DS1, verifies whether the first user data D1, received via the first requester account 230A, are issued by the first origin entity 120A.

In some embodiments, the first digital signature DS1 of the first user data D1 is generated by encrypting a cryptographic hash of the first user data D1 using an origin private key VK_{O} associated with the first origin entity 120A, and the payload digital signature PDS of the payload data PD is generated by encrypting a cryptographic hash of the payload data PD using a requester private key VK_{R} associated with the first requester account 230A.

In some embodiments, the database 750 stores, for each of a plurality of user accounts, a respective requester public key associated with a respective organization user, and the plurality of user accounts are associated with a plurality of organization users 130. Further, in some embodiments, decrypting the payload digital signature PDS using the requester public key further comprises determining whether the first requester account 230A is an authorized user of the data verification application 104. In accordance with a verification of the payload data PD and a verification that the first requester account 230A is the authorized user of the data verification application 104, the first digital signature DS1 is decrypted using the origin public key BK_{O}.

In some embodiments, the payload data PD and the payload digital signature PDS are intercepted by a second requester account. The computing system 700 receives, from the second requester account, a second verification request to verify the first user data D1 associated with the first individual user 110A, the second request including the payload data PD and the payload digital signature PDS, and verifies the second requester account for reviewing the payload data PD, e.g., by extracting, from the database 750, a second public key associated with the second requester account and decrypting the payload digital signature PDS associated with the payload data PD using the second public key associated with the second requester account to generate a second decrypted signature. Further, in some embodiments, the computing system 700 verifies that the second requester account does not sign the payload data PD based on the second decrypted signature or determining that the second requester account is not an authorized user of the data verification application 104, and aborts decrypting the first digital signature DS1 of the first user data D1 associated with the first individual user 110A with the origin public key BK_{O}.

In some embodiments, the metadata associated with the set of users include one or more data processing criteria 210 for using the set of user data issued by the respective origin entity to the subset of the plurality of individual users 110. After identifying the first origin entity 120A, the computing system 700 extracts, from the database 750, a first data processing criterion 210A, and applies the first data processing criterion 210A to the first user data D1 associated with the first individual user 110A to generate a confirmation indicating whether the first user data D1 satisfy the first data processing criterion 210A.

In some embodiments, in accordance with a verification that the first user data D1 are issued by the first origin entity 120A, the computing system 700 generates a message 208 associated with the first individual user 110A based on the first user data D1 and a subset of the metadata 106. The subset of the metadata is associated with the first user data D1 and provided by the first origin entity 120A. The computing system 700 sends the message 208 to the first requester account 230A. Further, in some embodiments, the message 208 includes one or more of: the first user data D1, a confirmation indicating that the first user data D1 comply with a first data processing criterion 210A, a confirmation indicating that the first user data D1 does not comply with the first data processing criterion 210A.

In some embodiments, the first user data D1 include one or more of: an age, an account number, transaction data, an email address, an age of an email address, a password, and a flag indicating a personal status of the first individual user 110A that is embedded in the first digital signature DS1 generated using a private key VK_{O} of the first origin entity 120A.

In some embodiments, a mobile device 112A associated with the first individual user 110A stores the first digital signature DS1 of the first user data D1 in a digital wallet application 240, and the first user data D1 include personal information of the first individual user 110A that is embedded in the first digital signature DS1 generated using a private key of the first origin entity 120A. Further, in some embodiments, the personal information of the first individual user 110A has an encrypted format when the first user data D1 is received and stored in the mobile device 112A, and the personal information is not readable from a user interface of the digital wallet application 240. Further, in some embodiments, an electronic device associated with the first requester account 230A executes the data verification application 104 and imports the first digital signature DS1 of the first user data D1 from the digital wallet application 240 of the mobile device 112A.

Additionally, in some embodiments, the mobile device 112A generates an individual digital signature DSI associated with an individual data block IDB using an individual private key VK_{I}, and the individual data block IDB includes the first user data D1 and the first digital signature DS1 issued by the first origin entity 120A. The mobile device 112A sends the individual digital signature DSI and the individual data block IDB to the electronic device 132A associated with the first requester account 230A having an individual public key BK_{I} provided by the mobile device 112A. The electronic device 132A processes the individual digital signature DSI using the individual public key to verify that the mobile device 112A sends the individual data block IDB and generates the individual digital signature DSI. In accordance with a verification of the mobile device 112A, the electronic device 132A generates the data verification request 206 including the payload digital signature PDS based on a requester private key VK_{R}.

In some embodiments, the computing system 700 stores, in the memory, the first user data D1 and the first digital signature DS1 of the first user data D1 temporarily and purges, from the memory, the first user data D1 and the first digital signature DS1 of the first user data D1.

In some embodiments, the data verification request 206 includes an identifier of the first origin entity 120A providing the first digital signature DS1 of the first user data D1. The computing system 700 identifies the first origin entity 120A by searching a list of identifiers associated with authorized origin entities 120 for a match with the identifier of the first origin entity 120A.

In some embodiments, the computing system 700 obtains an identifier of the first requester account 230A by searching a list of identifiers associated with authorized requester accounts 230 for the identifier of the first requester account 230A.

In some embodiments, a verifiable data structure of the first user data D1 includes one or more of: an identifier of the first individual user 110A, first user data D1, user metadata including a data processing criterion associated with the first user data D1, an individual public key, an identifier of the first origin entity 120A, a digital signature of the first origin entity 120A, and a signature parameter of the digital signature of the first origin entity 120A. An electronic device associated with the first origin entity 120A sends the verifiable data structure of the first user data D1 to a mobile device 112A associated with the first individual user 110A.

In some embodiments, the computing system 700 provides to each of a plurality of origin entities 120 the respective origin public key BK_{O} and an associated origin private key VK_{O} configured to create the first digital signature DS1 by the first origin entity 120A.

It should be understood that the particular order in which the operations in FIG. 8 have been described are merely exemplary and are not intended to indicate that the described order is the only order in which the operations could be performed. One of ordinary skill in the art would recognize various ways to adjust objects adaptively in each image as described herein. Additionally, it should be noted that details of other processes described above with respect to FIGS. 1-7 are also applicable in an analogous manner to method 800 described above with respect to FIG. 8. For brevity, these details are not repeated here.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. Additionally, it will be understood that, although the terms “first,” “second,” etc. may be used herein to describe various elements, these elements should not be limited by these terms. These terms are only used to distinguish one element from another.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

Although various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages can be implemented in hardware, firmware, software or any combination thereof.

### Supplemental Information and Alternative Embodiments

Referring back to FIG. 2, four parties are described herein for data verification. The first party is a risk owner (e.g., an organization user 130) which utilizes data and metadata to make decisions about how to deal with a second party (e.g., an individual user 110). The data and a proportion of the metadata comes from a third party, the data origin (e.g., an origin entity 120). Further metadata used by the first party comes from a fourth party, the metadata distributor (e.g., a metadata distributor 140 or “MDD” as described herein). In many business transactions, a first party needs to have confidence in particular data about a second party. Data critical to decision making is typically sourced from a trusted third party. The reliability or trustworthiness of the data may be inferred from metadata; that is, additional quality indicators, metrics, characteristics of the data.

For example, the age of a second party is important when a first party is selling alcohol; the first party may infer the age from a driver license presented by the first party, and may gain confidence in the age data by examining the security characteristics of the license, checking that the photograph on the license matches the first party, and checking if the issuer of the license is recognized. In electronic commerce systems, the issuers of trustworthy license can be listed in an official register.

In some embodiments, the systems for data verification discussed herein, referred to as a data verification platform (DVP) for short, and related methods are configured to bring together origins of data and users of data to make data and metadata acceptable to a risk owner that depends on data values presented by an end user. In some embodiments, data origins in the DVP may remain complete strangers to risk owners and still be trusted. In some instances, risk owners may not need local legislation to legitimize foreign data for use by risk owners, because metadata distributors may be configured to programmatically and/or automatically understand the terms & conditions of data and metadata provided to the system.

For example, there may be a digital age verification via mobile (e.g., digital) driver licenses used by retailers of age-restricted goods and services to screen shoppers. Many drivers licensing authorities are state-based, and thus their digital proofs of age may be natively confined to a relatively small jurisdiction where respective state legislation is in force. This limitation stems only partially from narrowness of legislation. Legislation is not sufficient to make credentials acceptable to retailers. Even if legislation is enacted in the state where a retailer does business to legitimize digital proof of age from other states, the retailer's e-commerce server may also need to be configured with the root keys of all legitimate credential issuers so it can verify the digital signature on each proof. In some instances, the DVP is configured to perform the verification of the digital signature on the proof such that data from the origin, including origins that are distant or remote, is made clear and easy for a risk owner to understand. In some instances, one or more origins may be participants in the DVP.

### Definition

A verifiable credential is a digitally signed data structure containing some particular fact, plus a public key corresponding to a private key held in a wallet by the subject of the credential. The credential is signed by the origin, referred to in some instances as CAO.

In some embodiments, a presentation of a credential occurs when the subject sends a digitally signed message to a risk owner, signed using the subject credential private key.

It should be understood that these definitions are reasonably consistent across verifiable credential practice. In some embodiments, the present invention introduces verifiable data structures as a generalization of the concept of verifiable credential. Typical verifiable credentials, consistent with the above definition, contain facts about subjects that are usually humans or in some cases non-human actors such as IoT devices. A verifiable data structure on the other hand may relate to any subject including other data records. As digital supply chains grow more complex and become more critical to safety and wellbeing in the modern economy, it is important that properties of the data moving through those supply chains are accurate and reliable. For example, it is important in different settings for concerned parties to be able to verify the audit status of AI training data, the consent given by individuals for data about them to be used in AI training, and the precise algorithm that was used to generate an AI object or make an automated decision.

### Parties

Referring to FIG. 2, in some embodiments, the data verification platform includes four parties:
RO “Risk Owner”: the first party to a transaction, for example a risk owner may be an online liquor retailer.
S “Subject”: the second party to an age-sensitive transaction, namely the customer.
“Origin”: the trusted third party in an age-sensitive transaction, for example a department of motor vehicles, which is accepted by the first and second parties as authoritative over the data in question, namely the age of the subject S.
MDD “Metadata Distributor”: a fourth party that connects the risk owner RO to the DVP and other participants such as origin O and provides the risk owner RO with technological and contractual support.
DVP “Data Verification Platform” is a system of networks, databases and other subsystems that support the exchange of data and metadata between the four main parties.

The DVP may include a system of rules, business agreements, technical specifications, software, and hardware that allows participants to verify data. In some instances, the DVP includes one or more computing devices and/or processors configured to execute computer executable code to perform one or more of the functionalities of the DVP discussed herein. Dict. is a metadata dictionary maintained by the DVP containing authoritative copies of, for example:
technical specifications of all verifiable data structures in the DVP's scope of operations;
copies of or unambiguous references to the issuance rules of all origins in the DVP's scope of operations;
unambiguous names of origins, verifiable data structures and verifiable data structure fields in the DVP's scope of operations; and/or
root public key(s) for verifying digital signatures on verifiable data structures and presentations.

In some embodiments, these metadata are made available through alternate means such as separate metadata dictionaries operated by for example separate origins, or through databases associated with risk transaction software installed at risk owners. In some embodiments, the DVP is configured to ascertain the meaning of at least some verifiable data structures of one or more data origins included therein, and uniquely encode those meanings. In some embodiments, the DVP is configured to ascertain the meaning of each data structure of each data origin included therein, and uniquely encode those meanings. In some instances, by configuring the DVP to encode the meanings of data for data origins as discussed herein, when an RO decides on a given piece of verified data, there may be metadata (distributed by the DD) to support that decision. In some instances, the DVP may be industry specific and/or include vertically distributed DVP instances.

In some embodiments, the DVP or its participants are configured to verify data, and the verification of data may include, for example:
parsing a data structure that holds facts of interest. In some instances, parsing may include the use of tools (e.g., software, hardware) provided by the MDD for the expected verifiable data structure types.
automatically assuring that the data is formatted in accordance with the RO needs, so that the meaning of the data suits the RO's needs. For example, such assurance may be built in by the MDD when it equips the RO to parse data structures
checking metadata such as name of origin to make sure it's registered
checking metadata that indicates if data is intended to be used as the RO plans such metadata to encode usage may improve the functionality of the DVP
tracing digital signatures to confirm that signatories are approved participants in the DVP.

W is the digital wallet of the subject S that contains the private keys for respective verifiable data structures issued to S.

### Platform Participation

One or more metadata distributors and/or data origins must be registered by the DVP as participants. In certain embodiments, the DVP acts as a Root CA and signs the CA operating certificates of Certification Authorities associated with metadata distributors and/or data origins; the signature of the DVP Root CA serves to prove the fact of registration. The DVP may learn through the registration process details of the credentialing rules applied by the origin O, and add details to the metadata dictionary. In some embodiments, the value of certain Subject metadata contained in a verifiable data structure can indicate that the data is fit for purpose for certain applications; for example, a proof of age credential issued by any Australian driver license authority might be deemed suitable for use in purchasing liquor in the United States.

Some embodiments of the present invention include the fitness for purpose is determined by the DVP that may study the credentials of issuers, including in some instances world-wide issuers, and codify them in the metadata dictionary for access by MDDs. In some embodiments, the DVP may track international legislation for e.g. age proofing and encode relevant legal details in the metadata dictionary. In some embodiments, the origin O and metadata distributor MDD both have control of certification authority functions CA_{O} and CA_{MDD} respectively.

### Onboarding Process Example:

The metadata distributor MDD onboards a risk owner RO by executing a contract of a standard form set by the DVP.
The MDD provides the RO with software and hardware with which to accept data within the MDD's scope and automate the verification of the data.
The MDD provides the RO with copies of root public keys with which to verify digital signatures on credentials and presentations.
The MDD provides RO with lists of approved credential policy identifiers (see below).

### Credentialing Process Example

The following steps may be performed to prepare the participants of the DVP to process proof of age data. With reference to FIGS. 2 and 5: The data origin O establishes the age of subject S according to a set of age verification rules and issues S with a verifiable credential VD as proof of age.

The credential VD will include Subject metadata which can indicate or reference the age verification rules so that any RO using the credential can in theory determine if the rules are compatible with the RO's business requirements or in other words if the credential is fit for purpose. Regular PKI applications feature an example of such Subject metadata known as a “policy identifier” which codifies the verification rules that were applied in issuing a PKI certificate.

The VD is a data structure including the following fields:
Subject reference which can be a human subject's name, a pseudonym, customer reference number or other identifier;
Data about the Subject such as their age or a flag representing that the subject is at least as old as a legislated age limit of interest;
Subject metadata relating to the rules under which the Subject data was verified and/or conditions for use of the verifiable credential;
Subject Public Key BK_{I} (also called individual public key) corresponding to a private key held in the Subject's wallet W; The Subject's presentation of their credential may be signed using the private key and hence verified using the public key;
Origin name;
Origin signature applied to the verifiable credential using a private key controlled by the Origin in accordance with regular public key cryptography practice; and
Signature parameters such as algorithm to be used by the Risk Owner RO or other party to guide the verification of the signature.

Some embodiments of the present invention address a practical difficulty with verifiable credentials where receivers of credentials can find it difficult to determine if the credentialling rules are in fact compatible with the RO's business requirements. In regular verifiable credentials deployments, the receiver of a credential needs to understand the details of the credentialing rules which can be difficult if the issuer of the credential is in a distant jurisdiction or is otherwise at arm's length.

More details on different parties, associated participation, and example onboarding processes are also discussed above with reference to FIG. 1.

### Presentation Process Flow Example

In some embodiments, subject S wishes to make an age-sensitive purchase (e.g., an online liquor purchase) from a liquor store, i.e., risk owner RO.
Origin O (an authority recognized for vouching for individuals' ages e.g. a driver license issuer) provides Subject S with a verifiable proof of age credential VD.
In keeping with some practice in verifiable credentials and applied public key cryptography, the credential VD contains a copy of a Subject public key BK_{I} which corresponds to a private key controlled by the Subject through their wallet W (e.g., a digital wallet application 240).
Subject S initiates an age-sensitive purchase with risk owner RO.
The risk owner RO requests proof of age VD from Subject S.
Subject S responds to the request and digitally signs the response using the proof of age credential and sends the signed request to the risk owner RO.
The risk owner RO verifies the signature on the response of subject S using the root public keys previously provided by the metadata distributor MDD. In keeping with regular verifiable credential practice, this verification evinces that the Subject S was truly in control of the presentation of the credential VD.
The risk owner RO further verifies the signature on the credential VD of origin O using the root public keys previously provided by the metadata distributor MDD. In keeping with regular verifiable credential practice, this verification evinces that the credential VD was issued by a recognized data origin.
The risk owner RO checks that the credential policy identifier is included in a the approved list previously provided by the metadata distributor MDD, thus indicating that according to the MDD, the presented credential is fit for purpose.
Optionally, the risk owner RO requests further verification of metadata by the metadata distributor MDD, such as the standing of the credential policy identifier.
In the case of requesting further verification, MDD sends a response to the RO. The risk owner RO performs additional checks, as desired, and decides to accept or reject the subject S.
If the RO is satisfied by the verifications then the RO proceeds to deliver the age-sensitive purchase to Subject S.

### Preferred Embodiments

### 1. Age Verification

In some instances a data subject is required to prove their age to buy alcohol online. A digital driver license may present the necessary age data electronically by way of a message sent to the RO (i.e. alcohol merchant) together with cryptographic proof that the age is endorsed by a driver license authority and that the credential is in the right hands. No extraneous names, addresses, or driver license numbers need be shared. A verifiable digital proof may leverage the customary de facto role of driver license authorities in proving age.

Many drivers licensing authorities are state-based, and thus their digital proofs of age may be confined to a relatively small jurisdiction where respective state legislation is in force. This limitation stems partially from narrowness of legislation however legislation is not sufficient to make credentials acceptable to retailers. Even if the retailer has the benefit of clear legislation in their jurisdiction that legitimizes digital proof of age from other states, the retailer's e-commerce server also needs to be configured with metadata and the root public keys of legitimate credential issuers in other jurisdictions where customers might obtain proofs of age so it can verify those proofs and thus accept those customers.

Over time as multiple proofs of age become available in the market and multiple jurisdictions mandate age checking, the situation may arise where every merchant needs to have an arrangement to understand the meaning of proofs of age from every applicable origin and thus be able to accept customers presenting such proofs of age.

In some embodiments, the DVP of the present disclosure addresses the challenge in this sort of combinatorial explosion by intermediating risk owners wanting proof of age and the issuers of such proofs. In a DVP implemented to verify government credentials, the metadata distributors may have access to information covering the varying syntax, semantics, and detailed terms and conditions of credentials provided by the participating data origins. The metadata distributors are thus able to make proof of age understandable, acceptable and legally certain to risk owners, no matter where the proof has come from.

Some embodiments of the present invention introduce a new type of intermediary, namely the metadata distributer, which provides machine-readable information about credentials (that is, metadata) and thus enables risk owners or receivers of credentials to interpret the fitness for purpose of credentials with origins that are at arm's length. The metadata distributor will be configured to deal with risk owners and business applications with common interests in determining the fitness for purpose of credentials. The metadata distributer is able to work on behalf of multiple risk owners to review credentialling rules of origins in distant jurisdictions, review the regulatory and other requirements of local jurisdictions, make determinations of fitness for purpose of credentials, and codify those determinations in the form of e.g. metadata dictionaries made available to risk owners.

More details on some embodiments associated with age verification and additional embodiments are discussed above with reference to FIG. 2.

### 2. Push Payment Payee Verification

Authorized push payments, as discussed herein may include a payments system (e.g., a retail payment system, a push payments system) in which sums of money are transferred directly from a payor's bank account to a payee's bank account. For authorized push payments, transfers are initiated (e.g., pushed) by the payor and often authorized by the payor alone. To enhance ease of use, authorized push payments often utilize payee specific communication channels (e.g., payee's cell phone number and/or email addresses) as proxies for bank accounts so as to provide customers a more easily comprehensible way of referring to each other and directing payments. Cell phone numbers are more easily memorized and conveyed than bank account numbers. However, cell phone numbers and email addresses are also more easily acquired than bank account numbers thereby making it easier for fraudsters to attempt to defraud the payee and/or payor.

In some embodiments, participating banks in these push payments systems make payors solely responsible for verifying payees but payors can find this verification difficult because information required for verification is often sparse. Verification can be weak and thus fraud rates in authorized payments systems have increased in recent years. The DVP may be configured to provide means for authorized push payments payors to access enhanced data about payees and thus have better verification of payee details in order to detect and/or prevent fraud. In the case of push payments where the risk owner is the payor who seeks assurance of the payee and the data subject is the payee about whom the payor is trying to get more information, the DVP may be configured to provide enhanced data about payees available to payors such as:
the age of the payee account where the Origin is the payee's bank;
unusual transaction behavior of the payee account where the Origin is the payee's bank;
the age of a payee's mobile phone number where the Origin is the Payee's cell phone company; and
the age of a payee's email address where the Origin is the Payee's email provider.

By providing such enhanced data to the risk owner (in this case the payor), the risk owner may be more easily able to detect and/or prevent themselves from being defrauded.

### 3. Watermarking Generative AI Products

Generative Artificial Intelligence (AI) systems are able to produce images and written works (digital objects) that are difficult to differentiate from the works of human creators. To help combat counterfeiting and intellectual property theft, it is increasingly common for Generative AI outputs to be “watermarked”. In some embodiments, an AI watermark is a digital signature or similar cryptographic code generated by a public key cryptographic transformation of the AI-generated digital object. Any user of a Generative AI output is theoretically able to verify the watermark using a trusted public key associated with the watermarking process. There is a significant challenge in AI watermarking relating to the meaning of every different watermark. With an increasing number of watermark options arising, Users of AI and watermarks will find it difficult to access the specifications necessary to interpret a watermark created at arm's length.

Referring to FIG. 6, some embodiments of the present invention provide a means for Users of Generative AI to understand and interpret watermarks through an intermediary metadata distributor. With reference to FIG. 6, a Generative AI Model M operates on a set of Training Data TD which has been sourced from a number of individuals, one of whom is illustrated, namely I. Individual I gives consent 608 for data about them to be used for training the model M. Prior to training in this example, the training data is audited by an AI Auditor AA to provide assurance that the data satisfies relevant ethics and quality standards.

The model M at some time receives a prompt P to generate a digital object 620. Before being distributed to users, the generated digital object is watermarked by a watermarking process WM. A watermark includes a type of public key signature. Administrative information about the watermarking entity (including the nature of the entity's authority to apply watermarks) is contained in a verifiable credential (not shown) issued by an Origin OWM. Subsequently, the watermarked object 630 is sent to a user U.

In some embodiments, the watermark is verified by U using metadata and public keys provided by a metadata distributor MDD. Thus U is able to interpret the watermark, through knowledge of such details as the watermark process, the entity responsible for watermarking, the jurisdiction, and any terms and conditions applied by the watermarking entity. There are numerous stages in the data processing chain of events involved in AI where metadata can be important. Some embodiments of the present invention provide the means to secure the metadata along the data processing chain by enabling different processing entities to sign intermediate digital objects in a verifiable manner. In a similar fashion to the disclosures above concerning Origins of proof of age credentials, different processing entities are supported by verifiable data origins, as follows:
Individual I can be issued a verifiable credential by Origin OI with which to sign the data provided to the training set TD to indicate consent.
The custodian of Training data TD can be issued a verifiable credential by Origin OTD with which to sign and thus brand the data before it is input into the model M.
The AI Auditor AA can be issued a verifiable credential by Origin OAA with which to sign the audited data so that the data carries with it proof of compliance.
The entity running the AI Model can be issued a verifiable credential by Origin OM which can be used to prove matters of interest such as the precise algorithm and parameters used to create the object 630.

As with the previously mentioned embodiments, the Origins and metadata distributors in this embodiment are joined contractually to the DVP. Without the benefit of the metadata distributor and DVP of the present specification, verification of watermarks across the global AI ecosystem will be laborious.

In some embodiments, a system for data verification includes a metadata distributor. The metadata distributor reviews the contents of verifiable credentials in the origin's domain, and the requirements of risk owners in other domains, and warrants the fitness of certain credentials for certain purposes. The MDD signifies fitness for purpose by responding to formal queries from Risk Owners sent over APIs. For example, if a customer presents a Colorado Driver License to an Australian online liquor merchant as proof of age, the merchant can send a query to their MDD asking if the credential is acceptable in the merchant's place of business, and the MDD will respond yes or no. Or the MDD can bake into business logic provided to ROs the if-then-else conditions for accepting credentials for certain applications in the MDD's scope. The MDD accepts liability for the use of credentials issued by Origins at arm's length from the ROs. The MDD charges a fee for verifying the fitness for purpose of a credential.

### Supplemental Information on Verifiable Credentials

Some implementations include containers, presentation, key carriers, cryptographic material, “encryption” etc. Lots of things are “encrypted” in a security system. Colloquially, we usually “encrypt” data to make it secret. Digital signatures employ another type of encryption. On their own, digital signatures do not mask or hide the data which is signed. A digital signature is technically an extra piece of data (a cryptogram) that accompanies the data which has been signed.

Some implementations include digital signatures (which are created by operating on a piece of data using a private key of the signer and are verified by operating again on the signature code using a matching public key).

### Credential Issuance and Use

In some embodiments, a credential is issued by an Issuer to a Subject. This could be anything: proof of age, driver license, insurance card, social security number, bank account, school qualification, professional membership, trade license, proof of employment. When the uses their credential, the Subject presents the credential to a Relying Party (a.k.a. Risk Owner). In some embodiments, the credential confers specific rights, entitlements or authority to the Subject. A credential might just be data carried in a file or on a physical card.

### Verifying Who Issued the Credential

A cryptographically verifiable credential is verifiable insofar as it is digitally signed by the issuer, so that any party knowing the public key of the issuer can verify that the credential did come from that issuer. The digital signature is sometimes referred to as a “cryptogram” or “additional cryptographic material” which is unique to the issuer and provides assurance that the credential is genuine.

### Verifying Who Used the Credential

Equally important is cryptographically verifiable presentation. In some embodiments, a relying party desires assurance that a credential received over the network from a remote Subject was indeed presented by the proper Subject to whom the credential relates (let's set aside questions of delegation or shared credentials). The signature (i.e. cryptogram) of the issuer is not sufficient to verify presentation because that cryptogram can be copied by an attacker.

### Technology is Needed

In some embodiments, a verifiable credential uses digital signatures to mark each presentation as unique to the Subject and a transaction or session. This means that Subjects holding verifiable credentials need private keys and in turn need a containers and cryptographic processors. This sounds like a lot to ask. Indeed, in wild west cryptocurrency systems, users take it on themselves to manage a lot of software and hardware. Similarly, in “self-sovereign identity” systems, the problem space is wide open, applications are loosely specified, and there is a culture of self-reliance which can extend to roll-your-own code.

In some embodiments, simplifications apply and the private keys, cryptographic containers etc. are customized. SIM cards, chip payment cards, e-passports and mobile phone wallets all carry forms of cryptographically verifiable credentials.

### Breaking Down Verifiable Credentials

In some embodiments, a cryptographically verifiable credential (e.g., a VD 220 in FIG. 2) includes an assertion about a Subject in the form of a standardized data structure including:
data about the subject, such as their age (e.g., first user data D1 in FIG. 2);
a name or some other reference for the subject (could be their given name, a CRN, or a pseudonym to preserve privacy);
metadata including one or more of:
   a validity data range for the credential;
   the type of credential holder (container), where the issuer of a credential has total control over how the credential is carried; so a verifiable credential corresponding to an credit card for example will only be carried on a certain type of smartcard. This is important because private keys kept in chips are far better than private keys contained in regular memory. The difference is what makes Bitcoin held on hard drives famously fragile, as opposed to “hardware wallets”;
   precise machine-readable indicator of what the credential is intended to be used for—essentially all the ‘fine print’—sometimes in the form of a link to the rules for use, the credentialling processes, and/or terms and conditions. Thus the rules for using and relying on the credential are incorporated by reference via the credential metadata; and
   The value of the indicator, on its own, can often be used by receiver software to check if the credential is fit for purpose. For example, credentials issued for proof of age by different state government operated driver license bureaus would include values that map to respective state government regulations for age proofing;
a public key of the subject used for signing presentations (e.g., public key BK_{O} in FIG. 2); and
the signature of the issuer (e.g., first digital signature DS1).

More details on verifiable credentials are discussed above with reference to FIGS. 2 and 5.

### Wallets

In some embodiments, the term of art for the container holding a Subject's private key(s)—and also, usually, the cryptographic processor—is wallet, sometimes digital wallet, smart wallet, or mobile wallet. Typically the wallet is situated in a mobile phone. There will be a user interface (UI) that portrays one or more credentials so the user can select a credential when applicable. “Wallet” is really an abstraction; most users will regard their digital wallet as an application on a phone, unaware of the secure storage and processing associated with it. It is best practice for each credential to have a separate unique private key.

Several variations are now described.

First, native wallets a.k.a. platform wallets such as Entity X Wallet and Entity C Wallet. These are standard features of the respective operating systems, with strict rules governing the types of issuers allowed to install credentials on the handsets. Controversially, Entity X charges extra transaction fees for payments done from bank cars in their wallet. On the other hand, the platforms invest heavily in handset security and they undertake important due diligence before admitting issuers onto the platform, so the platforms can justify the charges. In principle many different issuers and credential types might be involved.

Second, proprietary wallets are features of separate software apps, and carry credentials that are usually more specific to the apps. For example, state government service applications can feature multiple credentials. For example, a service application includes a carousel into which the customer can load their digital driver license, recreational fishing license, national park camping permits, children permit, and other state-sanctioned trade qualifications.

Third, open wallets are coming, from the open source community as an alternative to the native platform wallets. The open wallet is likely to be a suite of software components that third party application developers can use instead of submitting to the tight controls of the platforms.

Fourth, cloud wallets where the private key(s) and cryptographic processing are managed on a remote server on behalf of the Subject.

### Onboarding Flow—A Model: Virtual Bank Cards and Mobile Wallets

In some embodiments, a virtual credit card is a verifiable credential signed by a bank and issued to an account holder's mobile phone (e.g., a mobile phone 112A in FIG. 2). Usually the account holder is an established customer with a plastic card, and the new virtual card is a sort of digital twin. The twinned credit card must be loaded to a mobile phone under the control of the account holder, but the bank does not control that phone directly. But the bank can control a banking application loaded to the customer phone, so it usually uses such an application to gate the loading of its cards to the wallet. So loading a virtual credit card is usually a two stage process.

We start with a customer A (e.g., first user 110A in FIG. 2) in good standing with Bank B and holding a credit card account. Let's say customer A uses a mobile phone.
Entity C, a cell phone maker issuing a digital wallet, does due diligence on Bank B, decides that the bank is a fit and proper credit card issuer, and provides Bank B with programmatic access to the Entity C handset secure element chip via secure API (that is, Entity C gives Bank B the access credentials for an API through which verifiable credit card credentials can be loaded to the digital wallet in any compatible phone).
Establish the banking app
   A goes to an application store and downloads the Bank B application.
   For customer A to activate the banking application she needs to communicate with Bank B and provide assurance that she is the correct customer; which may be implemented using established passwords and personal details, maybe a onetime password generator; some banks might require the customer to come into a branch for in-person identification. The result is that Bank B activates the app, and in the bank's customer records, there will likely be some security data specific to the actual phone on which the application is installed.
   Thereafter, whenever that instance of the Bank B application is opened, it can be assumed that customer A is in control of the application.
Provision the virtual card to customer A's wallet.
   A opens her Bank Bing application and navigates to a “load card” function.
   A opts to load a twin of an existing credit card held with Bank B and clicks a button which communicates her intent electronically to Bank B.
   A server at Bank B uses the previously configured secure API of Entity C to install a verifiable credential to the Entity C wallet of customer A's phone.
   In more detail, the wallet in customer A's phone and the Bank B server carry out a coordinated series of sub-steps which include:
      Instructing the secure element in the phone to generate a public-private asymmetric key pair;
      Exporting a copy of the public key from the secure element to the Bank B server;
      Including a copy of the public key into a verifiable credential data structure;
      Digitally signing the verifiable credential data structure on behalf of Bank B; and
      Sending a copy of the signed credential back to the Entity C wallet.

### Card Presentation

Thereafter, customer A (e.g., first user 110A in FIG. 2) will see her credit card in the Entity C wallet on her phone, and will be able to present that credit card in whatever manner is supported by Entity C and card-accepting merchants such as “tap-to-pay” where the credit card is presented over a contactless radiofrequency interface to a physical merchant terminal or “click-to-pay” where the credit card is presented digitally over the internet to an e-commerce service.

### Onboarding Verifiable Data Structure

We start with a Subject A (e.g., first user 110A in FIG. 2) about whom a certain piece of data has been established by a data Origin. For example, subject A has been issued a proof of age by the government of a certain state through a driver license agency. Let's say subject A uses a mobile phone.
Entity X, a cell phone maker issuing a digital wallet, does due diligence on the state driver license agency, decides that the agency is a fit and proper issuer of proof of age, and provides the agency with programmatic access to the Entity X handset secure element chip via a secure API (that is, Entity X gives to the agency a copy of the access credentials for an API through which verifiable credentials can be loaded to any Entity X wallet).
Establish a mobile government services application
   A goes to the Entity X application store and downloads the state government's citizen services application.
   For subject A to activate the government services app, she needs to communicate with the agency and provide assurance that she is the correct citizen, which may be implemented using established passwords and personal details as determined by the government's security policy; some governments might require the citizen to come into an office for in-person identification. The result is that the agency activates the particular instance of the application in subject A's handset.
   Thereafter, whenever that instance of the government services application is opened, it can be assumed that subject A is in control of the application.
Provision the proof of age to subject A's wallet.
   A opens her services application and navigates to a “load proof of age” function.
   A clicks a button which communicates her request for proof of age to the agency.
   A government server uses the previously configured secure API of Entity X to install a verifiable credential to the wallet of subject A's phone.
   In more detail, the Entity X wallet in subject A's phone and the government server carry out a coordinated series of sub-steps which include:
      Instructing the secure element in the phone to generate a public-private asymmetric key pair;
      Exporting a copy of the public key from the secure element to the government server;
      Including a copy of the public key in a verifiable credential data structure;
      Digitally signing the verifiable credential data structure on behalf of the government agency; and
      Sending a copy of the signed credential back to the Entity X wallet.

### Presenting Proof of Age

Thereafter, A will see her proof of age in the Entity X wallet on her phone, and will be able to present that proof in whatever manner is supported by Entity X and the merchants that choose to verify customers' age in this way. For example, A can tap-to-prove her age where the verifiable credential is presented over a contactless radiofrequency interface to a physical terminal. This mode of proof is applicable for e.g. checking the age of patrons entering a license venue. Alternatively, A can click-to-prove her age in a digital transaction with an age restricted e-commerce service e.g. online liquor sales.

To process a presented proof of age credential (e.g., a VD 220 in FIG. 2 including first user data D1), the e-commerce server software needs to have knowledge of:
all issuers of proof of age that are deemed acceptable by the relying party business;
the values of all particular pieces of metadata that indicate fitness for purpose; for example, target values of the machine-readable indicator of intended use;
the values of all public keys for verifying the digital signatures of issuers (data Origins); and
the values of all public keys (e.g., keys BK_{O} and BK_{R} in FIG. 2) for verifying the digital signatures (e.g., PDS and DS1 FIG. 2) in of wallets on presentations.

To be concrete, in a country that widely utilizes digital proof of age, at a given time there might be three state issuers of verifiable age proofing credentials: A, B and C. The three issuers publish public keys PuKA, PuKB and PuKC for verifying their respective credential signatures. The three issuers operate according to age proofing regulations that are uniquely indicated by metadata values Reg #A, Reg #B and Reg #C respectively. Consider that all online liquor merchants in state X have been advised that the regulations of states A and C are fit for purpose in state X but that the regulation of state B is not. The e-commerce software of each online liquor merchant in state X would be programmed with the following logic to process credentials presented by would-be customers:

if (issuer == a) and (metadata == reg#a) and (signature verifies by puka)
then accept customer proof of age
else if (issuer == c) and (metadata == reg#c) and (signature verifies by
pukc)
then accept customer proof of age
else reject customer proof of age.

### Analysis of Credentials

For a verifiable credential to be reliable in a certain application, the relying party (a.k.a. risk owner) application software needs to be able to ascertain more or less automatically if a credential (e.g., a VD 220 in FIG. 2) presented by a Subject was intended to be used for the purpose of the application. As mentioned above, the rules for using and relying on a verifiable credential may be incorporated by reference via the credential metadata such as a machine-readable indicator of what the credential is intended to be used for. Fir reference, in traditional X.509 public key infrastructure, digital certificates included a “Certificate Policy Object Identifier” which was a globally unique designation of a detailed document published by the certificate issuer specifying how the certificate was issued, its intended usage, any prohibited usage etc. The Certificate Policy Object Identifier is a type of metadata which can be used by receiver software to check if the credential presented is fit for purpose.

Consider proof of age. Verifiable credentials (e.g., a VD 220 in FIG. 2) issued for proof of age by different state government operated driver license bureaus would include reference to respective state government regulations for age proofing. The state of New South Wales would have regulations that cover who is eligible for a proof of age, what they are allowed to use that proof of age for, any prohibited uses or other restrictions, and legal protections available to businesses that rely on proof of age issued by a government agency.

Another state, say Victoria, will have its own regulations that cover its proof of age credentials. In a federation such as Australia's it is generally expected that state-issued proof of age will be usable when dealing with businesses located interstate. That is, a holder of a New South Wales based verifiable proof of age credential should be able to present that credential to a liquor store operating in Victoria and expect the store to recognize the proof. However there might always be restrictions or other ‘fine print’ in one state's age proofing regulations that should be heeded by any relying party operating in another state that is contemplating the use of the credential. In other words, the operator of an age-restricted retail business needs to have their software programmed with knowledge of the fitness for purpose of all interstate credentials that may reasonably be expected to be presented by potential customers seeking to purchase that business's product. This knowledge amounts to legal advice to the business about interstate age proofing regulations.

In a federation such as Australia or the United States, there would typically be dozens of retail businesses in each state each of which might seek to accept customers' proof of age originating from potentially any other state driver license issuer. Dozens of businesses each needing to decide on the fitness for purpose of every potential proof of age leads to a combinatorial explosion in pieces of advice pertaining to fitness for purpose.

More details on verifying user data using data processing criteria are discussed above with reference to FIG. 2.

### Metadata Distribution

Any relying party (risk owner) wanting to accept verifiable data faces the combinatorial complexity of having to:
understand the detailed format of all verifiable data structures that might be presented;
evaluate all potential issuers (origins) as to whether they are fit for purpose for the relying party's application, in the relying party's location (remembering that issuers are likely to be indifferent jurisdictions);
obtain trusted copies of the metadata targets; and
obtain trusted copies of the issuer's public keys.

Some embodiments of the present invention include a new type of intermediary—the metadata distributor—which takes on the task of reviewing the rules (e.g., data processing criterion 210A in FIG. 2) for each type of verifiable credential expected to be presented, and distributing metadata (e.g., metadata 106 in FIG. 1) to relying party software to enable the software to automatically recognize relevant credential types and accept them (or not) accordingly. The MDD provides software components (such as the example logic outlined above) and configuration files containing metadata target values that express the business rules. A metadata distributer supports one or more relying parties in much the same way as an Acquiring Bank supports one or more merchants in a credit card scheme. Relative to the Risk Owner, data Subject and data Origin, the MDD is a fourth party. The Data Verification Platform is a higher level structure that brings the four parties together through contracts executed between the DVP and the Origins, and between the DVP and the MDDs.

### Other Applications (and Possible Patent Claims)

In some embodiments, the Subject is an author under contract with a publisher who issues a verifiable credential asserting the author's standing with the publisher. The author uses the verifiable credential to digitally sign their work, thus providing assurance to potentially any reader that the work is that of the author under the auspices of the publisher. A metadata distributor established within the publishing industry makes metadata available to readers to render the publisher and author details legible. The Subject is a Generative AI operated by a media company which issues a verifiable credential asserting their control of the Generative AI. The Generative AI uses the verifiable credential to digitally sign its work, thus providing assurance to any potentially reader that the work is that of the Generative AI under the auspices of the media company.

1. A computer implemented method, comprising:
at a computing system having one or more processors and memory for storing one or more instructions:
executing a data verification application for verifying user data of a plurality of individual users on behalf of a plurality of origin entities that issue the user data, wherein the data verification application is coupled to a database that stores, for each of a plurality of origin entities, (1) a respective origin public key corresponding to a set of user data issued by the respective origin entity to a subset of the plurality of individual users and (2) metadata that is associated with the set of user data and provided by the respective origin entity;
receiving, from a first requester account, a data verification request including payload data and a payload digital signature associated with the payload data, the payload data further including first user data of a first individual user and a first digital signature associated with the first user data; and
in response to the data verification request:
extracting, from the database, a requester public key associated with the first requester account;
decrypting the payload digital signature associated with the payload data using the requester public key associated with the first requester account to generate a decrypted payload digital signature;
based on the decrypted payload digital signature, verifying whether the payload data, received from the first requester account, are generated by the first requester account; and
in accordance with a verification of the payload data:
obtaining the payload data including the first digital signature and the first user data of the first individual user;
identifying a first origin entity that has issued the first user data of the first individual user based on the payload data;
extracting, from the database, an origin public key associated with the first origin entity;
decrypting the first digital signature associated with the first user data using the origin public key associated with the first origin entity to generate a decrypted first digital signature; and
based on the decrypted first digital signature, verifying whether the first user data, received via the first requester account, are issued by the first origin entity.

2. The method of claim 1, wherein the first digital signature of the first user data is generated by encrypting a cryptographic hash of the first user data using an origin private key associated with the first origin entity, and the payload digital signature of the payload data is generated by encrypting a cryptographic hash of the payload data using a requester private key associated with the first requester account.

3. The method of claim 1, wherein the database stores, for each of a plurality of user accounts, a respective requester public key associated with a respective organization user, and the plurality of user accounts are associated with a plurality of organization users.

4. The method of claim 3, wherein:
decrypting the payload digital signature using the requester public key further comprises determining whether the first requester account is an authorized user of the data verification application; and
in accordance with a verification of the payload data and a verification that the first requester account is the authorized user of the data verification application, the first digital signature is decrypted using the origin public key.

5. The method of claim 3, wherein the payload data and the payload digital signature are intercepted by a second requester account, the method further comprising:
receiving, from the second requester account, a second verification request to verify the first user data associated with the first individual user, the second verification request including the payload data and the payload digital signature; and
verifying the second requester account for reviewing the payload data.

6. The method of claim 5, verifying the second requester [user] account further comprising, in response to the second verification request:
extracting, from the database, a second public key associated with the second requester account;
decrypting the payload digital signature associated with the payload data using the second public key associated with the second requester account to generate a second decrypted signature;
verifying that the second requester account does not sign the payload data based on the second decrypted signature or determining that the second requester account is not an authorized user of the data verification application; and
aborting decrypting the first digital signature of the first user data associated with the first individual user with the origin public key.

7. The method of claim 1, wherein the metadata associated with the set of users include one or more data processing criteria for using the set of user data issued by the respective origin entity to the subset of the plurality of individual users, the method further comprising:
after identifying the first origin entity, extracting, from the database, a first data processing criterion;
applying the first data processing criterion to the first user data associated with the first individual user to generate a confirmation indicating whether the first user data satisfy the first data processing criterion.

8. The method of claim 1, further comprising:
in accordance with a verification that the first user data are issued by the first origin entity, generating a message associated with the first individual user based on the first user data and a subset of the metadata, wherein the subset of the metadata is associated with the first user data and provided by the first origin entity; and
sending the message to the first requester account.

9. The method of claim 8, wherein the message includes one or more of: the first user data, a confirmation indicating that the first user data comply with a first data processing criterion, a confirmation indicating that the first user data does not comply with the first data processing criterion.

10. The method of claim 1, wherein the first user data include one or more of: an age, an account number, transaction data, an email address, an age of an email address, a password, and a flag indicating a personal status of the first individual user that is embedded in the first digital signature generated using a private key of the first origin entity.

11-22. (canceled)

23. A computing system, comprising:
one or more processors; and
memory having instructions stored thereon, which when executed by the one or more processors cause the processors to perform operations for:
executing a data verification application for verifying user data of a plurality of individual users on behalf of a plurality of origin entities that issue the user data, wherein the data verification application is coupled to a database that stores, for each of a plurality of origin entities, (1) a respective origin public key corresponding to a set of user data issued by the respective origin entity to a subset of the plurality of individual users and (2) metadata that is associated with the set of user data and provided by the respective origin entity;
receiving, from a first requester account, a data verification request including payload data and a payload digital signature associated with the payload data, the payload data further including first user data of a first individual user and a first digital signature associated with the first user data; and
in response to the data verification request:
extracting, from the database, a requester public key associated with the first requester account;
decrypting the payload digital signature associated with the payload data using the requester public key associated with the first requester account to generate a decrypted payload digital signature;
based on the decrypted payload digital signature, verifying whether the payload data, received from the first requester account, are generated by the first requester account; and
in accordance with a verification of the payload data:
obtaining the payload data including the first digital signature and the first user data of the first individual user;
identifying a first origin entity that has issued the first user data of the first individual user based on the payload data;
extracting, from the database, an origin public key associated with the first origin entity;
decrypting the first digital signature associated with the first user data using the origin public key associated with the first origin entity to generate a decrypted first digital signature; and
based on the decrypted first digital signature, verifying whether the first user data, received via the first requester account, are issued by the first origin entity.

24. The computing system of claim 23, wherein a mobile device associated with the first individual user stores the first digital signature of the first user data in a digital wallet application, and the first user data include personal information of the first individual user that is embedded in the first digital signature generated using a private key of the first origin entity.

25. The computing system of claim 24, wherein the personal information of the first individual user has an encrypted format when the first user data is received and stored in the mobile device, and the personal information is not readable from a user interface of the digital wallet application.

26. The computing system of claim 24, wherein an electronic device associated with the first requester account executes the data verification application and imports the first digital signature of the first user data from the digital wallet application of the mobile device, the memory further comprising instructions for:
generating, by the mobile device, an individual digital signature associated with an individual data block using an individual private key, the individual data block including the first user data and the first digital signature issued by the first origin entity;
sending the individual digital signature and the individual data block to the electronic device associated with the first requester account having an individual public key provided by the mobile device;
processing, by the electronic device, the individual digital signature using the individual public key to verify that the mobile device, sending the individual data block, generates the individual digital signature; and
in accordance with a verification of the mobile device, generating the data verification request including the payload digital signature based on a requester private key.

27. The computing system of claim 23, the memory further comprising instructions for:
storing, in the memory, the first user data and the first digital signature of the first user data temporarily; and
purging, from the memory, the first user data and the first digital signature of the first user data.

28. A non-transitory computer-readable storage medium, having instructions stored thereon, which when executed by one or more processors of a computing system cause the processors to perform operations comprising:
executing a data verification application for verifying user data of a plurality of individual users on behalf of a plurality of origin entities that issue the user data, wherein the data verification application is coupled to a database that stores, for each of a plurality of origin entities, (1) a respective origin public key corresponding to a set of user data issued by the respective origin entity to a subset of the plurality of individual users and (2) metadata that is associated with the set of user data and created by the respective origin entity;
receiving, from a first requester account, a data verification request including payload data and a payload digital signature associated with the payload data, the payload data further including first user data of a first individual user and a first digital signature associated with the first user data; and
in response to the data verification request:
extracting, from the database, a requester public key associated with the first requester account;
decrypting the payload digital signature associated with the payload data using the requester public key associated with the first requester account to generate a decrypted payload digital signature;
based on the decrypted payload digital signature, verifying whether the payload data, received from the first requester account, are generated by the first requester account; and
in accordance with a verification of the payload data:
obtaining the payload data including the first digital signature and the first user data of the first individual user;
identifying a first origin entity that has issued the first user data of the first individual user based on the payload data;
extracting, from the database, an origin public key associated with the first origin entity;
decrypting the first digital signature associated with the first user data using the origin public key associated with the first origin entity to generate a decrypted first digital signature; and
based on the decrypted first digital signature, verifying whether the first user data, received via the first requester account, are issued by the first origin entity.

29. The non-transitory computer-readable storage medium of claim 28, wherein the data verification request includes an identifier of the first origin entity providing the first digital signature of the first user data, and identifying the first origin entity further comprises:
searching a list of identifiers associated with authorized origin entities for a match with the identifier of the first origin entity.

30. The non-transitory computer-readable storage medium of claim 28, further comprising instructions for:
obtaining an identifier of the first requester account;
searching a list of identifiers associated with authorized requester accounts for the identifier of the first requester account.

31. The non-transitory computer-readable storage medium of claim 28, wherein a verifiable data structure of the first user data includes one or more of: an identifier of the first individual user, first user data, user metadata including a data processing criterion associated with the first user data, an individual public key, an identifier of the first origin entity, a digital signature of the first origin entity, and a signature parameter of the digital signature of the first origin entity, the non-transitory computer-readable storage medium further comprising instructions for:
sending, by the first origin entity, the verifiable data structure of the first user data to a mobile device associated with the first individual user.

32. The non-transitory computer-readable storage medium of claim 28, further comprising instructions for:
providing to each of a plurality of origin entities the respective origin public key and an associated origin private key configured to create the first digital signature by the respective origin entity.
